(19) United States
(12) Patent Application Publication
(10) Pub. No.: US 2014/0234606 A1
(43) Pub. Date: Aug. 21, 2014

(54) NETTING, ARRAYS, AND DIES, AND METHODS OF MAKING THE SAME

(71) Applicants: Ronald W. Ausen, St. Paul, MN (US); Timothy J. Diekmann, Maplewood, MN (US); Thomas P. Hanschen, Mendota Heights, MN (US); William J. Kopecky, Hudson, WI (US); Shou-Lu Wang, Woodbury, MN (US)

(72) Inventors: Ronald W. Ausen, St. Paul, MN (US); Timothy J. Diekmann, Maplewood, MN (US); Thomas P. Hanschen, Mendota Heights, MN (US); William J. Kopecky, Hudson, WI (US); Shou-Lu Wang, Woodbury, MN (US)

(21) Appl. No.: 14/240,062

(22) PCT Filed: Aug. 21, 2012
(86) PCT No.: PCT/US2012/051660

§ 371 Date: Feb. 21, 2014

Related U.S. Application Data
(60) Provisional application No. 61/526,001, filed on Aug. 22, 2011.

(51) Int. Cl. B29D 28/00

(52) U.S. Cl. CPC B29D 28/00
USPC 428/220; 264/177.1; 425/131.1

(57) ABSTRACT

Nettings and arrays comprising polymeric strands, including dies (1030) and methods to make the same. Nettings and arrays of polymeric strands (1070a,1070b) described herein have a variety of uses, including wound care, tapes, filtration, absorbent articles, pest control articles, geotextile applications, water/vapor management in clothing, reinforcement for non-woven articles, self bulking articles, floor coverings, grip supports, athletic articles, and pattern-coated adhesives.

### CROSS REFERENCE TO RELATED APPLICATION

This application claims the benefit of U.S. Provisional Patent Application No. 61/526,001, filed Aug. 22, 2011, the disclosure of which is incorporated by reference herein in its entirety.

### BACKGROUND

Polymeric nets are used for a wide variety of applications, including reinforcement of paper articles or cheap textiles (e.g., in sanitary paper articles, paper cloth, and heavy duty bags), non-woven upholstery fabrics, window curtains, decorative netting, wrapping material, mosquito netting, protective gardening netting against insects or birds, backing for growing of grass or plants, sport netting, light fishing netting, and filter materials.

Extrusion processes for making polymeric nets are well known in the art. Many of these processes require complex dies with moving parts. Many of these processes can only be used to produce relatively thick netting with relatively large diameter strands and/or relatively large mesh or opening sizes.

Polymeric netting can also be obtained from films by slitting a pattern of intermittent lines, which are mutually staggered, and expanding the slit film while stretching biaxially. This process tends to produce netting of a relatively large mesh and with relatively weak cross-points.

There exists a need for a relatively simple and economical process for producing polymeric netting having a wide variety of strand diameters and mesh or opening sizes.

### SUMMARY

In one aspect, the present disclosure describes a netting comprising an array of polymeric strands (in some embodiments. at least alternating first and second (optionally third, fourth, or more) polymeric strands) periodically joined together at bond regions throughout the array, but do not substantially cross over each other (i.e., at least 50 (at least 55, 60, 65, 70, 75, 80, 85, 90, 95, 99, or even 100) percent by number), wherein the netting has a thickness up to 750 micrometers (in some embodiments, up to 500 micrometers, 250 micrometers, 100 micrometers, 75 micrometers, 50 micrometers, or even up to 25 micrometers; in a range from 10 micrometers to 750 micrometers, 10 micrometers to 750 micrometers, 10 micrometers to 500 micrometers, 10 micrometers to 250 micrometers, 10 micrometers to 100 micrometers, 10 micrometers to 75 micrometers, 10 micrometers to 50 micrometers, or even 10 micrometers to 25 micrometers). For embodiments having first and second polymeric strands, the polymers of the first and second polymeric strands may be the same or different.

In another aspect, the present disclosure describes an attachment system comprising a netting (optionally additional netting described herein to provide multiple (i.e., 2 or more) layers of netting) and an array of engagement posts (e.g., hooks) for engaging with the netting, the netting comprising an array of polymeric strands (in some embodiments. at least alternating first and second (optionally third, fourth, or more) polymeric strands) periodically joined together at bond regions throughout the array, wherein the netting has a thickness up to 750 micrometers (in some embodiments, up to 500 micrometers, 250 micrometers, 100 micrometers, 75 micrometers, 50 micrometers, or even up to 25 micrometers; in a range from 10 micrometers to 750 micrometers, 10 micrometers to 750 micrometers, 10 micrometers to 500 micrometers, 10 micrometers to 250 micrometers, 10 micrometers to 100 micrometers, 10 micrometers to 75 micrometers, 10 micrometers to 50 micrometers, or even 10 micrometers to 25 micrometers). For embodiments having first and second polymeric strands, the polymers of the first and second polymeric strands may be the same or different. Typically, the engagement posts described herein are attached to a backing.

In another aspect, the present disclosure describes an attachment system comprising an array of engagement posts (e.g., hooks) engaged with a netting (optionally additional netting described herein to provide multiple (i.e., 2 or more) layers of netting), the netting comprising polymeric strands (in some embodiments. at least alternating first and second (optionally third, fourth, or more) polymeric strands) periodically joined together at bond regions throughout the array, wherein the netting has a thickness up to 750 micrometers. For embodiments having first and second polymeric strands, the polymers of the first and second polymeric strands may be the same or different. Typically, the engagement posts described herein are attached to a backing.

In another aspect, the present disclosure describes an array of alternating first and second polymeric strands, wherein the first and second strands periodically join together at bond regions throughout the array, wherein the first strands have average first yield strength, and wherein the second strands have an average second yield strength that is different (e.g., at least 10 percent different) than the first yield strength. Typically, the netting has a thickness up to 2 mm (in some embodiments, up to 1.5 mm, 1 mm, 750 micrometers, 500 micrometers, 250 micrometers, 100 micrometers, 75 micrometers, 50 micrometers, or even up to 25 micrometers; in a range from 10 micrometers to 2 mm, 10 micrometers to 1.5 mm, 10 micrometers to 1 mm, 10 micrometers to 750 micrometers, 10 micrometers to 500 micrometers, 10 micrometers to 250 micrometers, 10 micrometers to 100 micrometers, 10 micrometers to 75 micrometers, 10 micrometers to 50 micrometers, or even 10 micrometers to 25 micrometers), although it is believed that thicknesses greater than 2 mm may also be useful. In some embodiments, the polymers of the first and second polymeric strands are the same or while in others they are different.

In another aspect, the present disclosure describes an extrusion die comprising a plurality of shims positioned adjacent to one another, the shims together defining a cavity and a dispensing surface, wherein the dispensing surface has an array of first dispensing orifices alternating with an array of second dispensing orifices, wherein the plurality of shims comprises a plurality of a repeating sequence of shims comprising a shim that provides a fluid passageway between the cavity and the first dispensing orifices and a shim that provides a fluid passageway between the cavity and the second dispensing orifices, wherein the first array of fluid passageways has greater fluid restriction than the second array of fluid passageways. Typically, the fluid passageway between cavity and dispensing orifice is up to 5 mm in length.

In another aspect, the present disclosure describes an extrusion die comprising a plurality of shims positioned adjacent to one another, the shims together defining a first cavity, a second cavity, and a dispensing surface, wherein the dispensing surface has an array of first dispensing orifices alternating with an array of second dispensing orifices, wherein the plurality of shims comprises a plurality of a repeating sequence of shims comprising a shim that provides a fluid passageway between the first cavity and one of the first dispensing orifices and a shim that provides a fluid passageway between the second cavity and one of second the dispensing orifices. Typically, the fluid passageway between a cavity and a dispensing orifice is up to 5 mm in length. Typically, each of the dispensing orifices of the first and the second arrays have a width, and each of the dispensing orifices of the first and the second arrays are separated by up to 2 times the width of the respective dispensing orifice.

In another aspect, the present disclosure describes an extrusion die comprising a plurality of shims positioned adjacent to one another, the shims together defining a cavity and a dispensing surface, wherein the dispensing surface has at least one net-forming zone and at least one ribbon-forming zone, wherein the net-forming zone has an array of first dispensing orifices alternating with an array of second dispensing orifices. In some embodiments, each of the dispensing orifices of the first and the second arrays have a width, and each of the dispensing orifices of the first and the second arrays are separated by up to 2 times the width of the respective dispensing orifice.

In another aspect, the present disclosure describes an extrusion die comprising a plurality of shims positioned adjacent to one another, the shims together defining a first cavity, a second cavity, and a dispensing surface, wherein the dispensing surface has at least one net-forming zone and at least one ribbon-forming zone, wherein the net-forming zone has an array of first dispensing orifices alternating with an array of second dispensing orifices. In some embodiments, each of the dispensing orifices of the first and the second arrays have a width, and each of the dispensing orifices of the first and the second arrays are separated by up to 2 times the width of the respective dispensing orifice.

In another aspect, the present disclosure describes a method of making netting and arrays of polymeric strands described herein, the method comprising one of Method I or Method II:

Method I

providing an extrusion die comprising a plurality of shims positioned adjacent to one another, the shims together defining a cavity, the extrusion die having a plurality of first dispensing orifices in fluid communication with the cavity and a plurality of second dispensing orifices in fluid communication with the cavity, such that the first and second dispensing orifices are alternated; and

dispensing first polymeric strands from the first dispensing orifices at a first strand speed while simultaneously dispensing second polymeric strands from the second dispensing orifices at a second strand speed, wherein the first strand speed is at least 2 (in some embodiments, in a range from 2 to 6, or even 2 to 4) times the second strand speed to provide the netting (i.e., the first and second dispensing orifices in fluid communication with the (single) cavity such that in use the first and second strand speeds are sufficiently different to produce net bonding); or

Method II

providing an extrusion die comprising a plurality of shims positioned adjacent to one another, the shims together defining a first cavity and a second cavity, the extrusion die having a plurality of first dispensing orifices in fluid communication with the first cavity and having a plurality of second dispensing orifices connected to the second cavity, such that the first and second dispensing orifices are alternated; and

dispensing first polymeric strands from the first dispensing orifices at a first strand speed while simultaneously dispensing second polymeric strands from the second dispensing orifices at a second strand speed, wherein the first strand speed is at least 2 (in some embodiments, in a range from 2 to 6, or even 2 to 4) times the second strand speed to provide the netting. In some embodiments, the plurality of shims comprises a plurality of a repeating sequence of shims that includes a shim that provides a passageway between the first cavity and at least one of the first dispensing orifices and a shim that provides a passageway between the second cavity and the at least one of the second dispensing orifices. In some embodiments, the polymers of the first and second polymeric strands are the same, while in others they are different.

Nettings and arrays of polymeric strands described herein have a variety of uses, including wound care and other medical applications (e.g., elastic bandage-like material, surface layer for surgical drapes and gowns, and cast padding), tapes (including for medical applications), filtration, absorbent articles (e.g., diapers and feminine hygiene products) (e.g., as a layer(s) within the articles and/or as part of an attachment system for the articles, including additional netting described herein to provide multiple (i.e., 2 or more) layers of netting)), pest control articles (e.g., mosquito nettings), geotextile applications (e.g., erosion control textiles), water/vapor management in clothing, reinforcement for nonwoven articles (e.g., paper towels), self bulking articles (e.g., for packaging) where the netting thickness is increased by stretching nettings having first and second strands with different (e.g., at least 10 percent different) yield strengths so that the strand having the lower yield strength plastically deforms, floor coverings (e.g., rugs and temporary mats), grip supports for tools, athletic articles, etc., and pattern-coated adhesives.

### BRIEF DESCRIPTION OF THE DRAWINGS

FIG. 1 is an exploded perspective view of an exemplary embodiment of a set of extrusion die elements of the present disclosure, including a plurality of shims, a set of end blocks, bolts for assembling the components, and inlet fittings for the materials to be extruded;

FIG. 2 is a plan view of one of the shims of FIG. 1;

FIG. 3 is a plan view of a different one of the shims of FIG. 1.

FIG. 4 is a perspective view of an exemplary extrusion die described herein;

FIG. 5 is a front view of a portion of a dispensing surface of an exemplary extrusion die (and used in Example 5);

FIG. 6 is an exploded perspective view of an alternate exemplary embodiment of an extrusion die according to the present disclosure, wherein the plurality of shims, a set of end blocks, bolts for assembling the components, and inlet fittings for the materials to be extruded are clamped into a manifold body;

FIG. 7 is a plan view of one of the shims of FIG. 7, and relates to FIG. 6 in the same way FIG. 2 relates to FIG. 1;

FIG. 8 is a plan view of a different one of the shims of FIG. 6, and relates to FIG. 6 in the way FIG. 3 relates to FIG. 1;

FIG. 9 is a perspective view of the embodiment of FIG. 6 as assembled;

FIG. 10 is a schematic perspective view of a portion of an exemplary extrusion die described herein supplied with polymeric material and forming a net;

FIG. 11 is a front view of a portion of the dispensing surface of an exemplary extrusion die described herein (and used in Examples 1 and 2);

FIG. 12 is a front view of a portion of the dispensing surface of an exemplary extrusion die described herein (and used in Example 4);

FIG. 13 is a digital optical image at 10× of an exemplary netting described herein (see Example 1);

FIG. 14 is a digital optical image at 10× of an exemplary netting described herein (see Example 2);

FIG. 15 is a front view of a portion of the dispensing surface of an exemplary extrusion die described herein (and used in Example 3);

FIG. 16 is a digital optical image at 10× of an exemplary netting described herein (see Example 3);

FIG. 17 is a digital optical image at 10× of an exemplary netting described herein (see Example 4);

FIG. 18 is a digital optical image at 10× of an exemplary netting described herein (see Example 5);

FIG. 19 is a digital optical image at 10× of an exemplary netting described herein (see Example 6);

FIG. 20 is a digital optical image at 10× of an exemplary netting described herein (see Example 7);

FIG. 21 is a digital optical image at 10× of an exemplary netting described herein (see Example 8);

FIG. 22 is a digital optical image at 10× of an exemplary netting described herein (see Example 9);

FIG. 23 is a digital optical image at 10× of an exemplary netting described herein (see Example 10);

FIG. 24 is a front view of a portion of the dispensing surface of an exemplary extrusion die described herein (and used in Example 11);

FIG. 25 is a digital optical image at 10× of an exemplary netting described herein (see Example 11);

FIG. 26 is a digital optical image at 10× of an exemplary netting described herein (see Example 12);

FIG. 27 is a front view of a portion of the dispensing surface of an exemplary extrusion die described herein (and used in Example 13);

FIG. 28 is a digital optical image at 10× of an exemplary netting described herein (see Example 13);

FIG. 29 is a front view of a portion of the dispensing surface of an exemplary extrusion die described herein (and used in Example 14);

FIG. 30 is a digital optical image at 10× of an exemplary netting described herein (see Example 14);

FIG. 31 is a digital optical image at 10× of an exemplary netting described herein (see Example 15);

FIG. 32 is a front view of a portion of the dispensing surface of an exemplary extrusion die described herein (and used in Example 16);

FIG. 33 is a digital photographic image at 10× of an exemplary netting described herein (see Example 16);

FIG. 34 is a front view of a portion of the dispensing surface of an exemplary extrusion die described herein (and used in Example 17);

FIG. 35 is a digital optical image at 10× of an exemplary netting described herein (see Example 17);

FIG. 36 is a digital optical image at 10× of an exemplary netting described herein (see Example 18);

FIG. 37 is a front view of a portion of the dispensing surface of an exemplary extrusion die described herein (and used in Example 19);

FIG. 38 is a digital optical image of an exemplary ribbon region-netting-film-netting-ribbon region article described herein (see Example 19);

FIG. 39 is a digital optical image at 10× of an exemplary netting described herein (see Example 20);

FIG. 40 is a digital optical image at 10× of an exemplary netting described herein exemplary having bond lines (see Example 21);

FIG. 41 is a digital optical image at 10× of an exemplary netting described herein having bond lines (see Example 22);

FIG. 42 is a digital optical image at 10× of an exemplary netting described herein having bond lines (see Example 23);

FIG. 43 is a digital optical image at 10× of an exemplary netting described herein having bond lines (see Example 24);

FIG. 44 is a plan view of an exemplary shim for making netting described herein extruded from a single cavity;

FIG. 45 is a plan view of an exemplary shim for making netting described herein in conjunction with the shim of FIG. 44;

FIG. 46 is a plan view of an exemplary spacer shim for making netting described herein in conjunction with the shims of FIG. 44 and FIG. 45;

FIG. 47 is a detail perspective view of a plurality of shims formed from the shims of FIGS. 45-47; and

FIG. 48 is a detail perspective view of the plurality of shims of FIG. 47, seen from the reverse angle, with one of the shims removed from visual clarity.

### DETAILED DESCRIPTION

Typically, in some embodiments, the plurality of shims comprises a plurality of a repeating sequence of shims that includes a shim that provides a passageway between a cavity and the dispensing orifices, or the plurality of shims comprises a plurality of a repeating sequence of shims that includes a shim that provides a passageway between the first cavity and at least one of the first dispensing orifices and a shim that provides a passageway between the second cavity and the at least one of the second dispensing orifice. Typically, not all of the shims of dies described herein have passageways; as some may be spacer shims that provide no passageway between a cavity and a dispensing orifice. In some embodiments, there is a repeating sequence that further comprises at least one spacer shim. The number of shims providing a passageway between the first cavity and a first dispensing orifice may be equal or unequal to the number of shims providing a passageway between the second cavity and a dispensing orifice.

In some embodiments, the first dispensing orifices and the second dispensing orifices are collinear. In some embodiments, the first dispensing orifices are collinear, and the second dispensing orifices are collinear but offset from the first dispensing orifices.

In some embodiments, extrusion dies described herein include a pair of end blocks for supporting the plurality of shims. In these embodiments it may be convenient for one or all of the shims to each have one or more through-holes for the passage of connectors between the pair of end blocks. Bolts disposed within such through-holes are one convenient approach for assembling the shims to the end blocks, although the ordinary artisan may perceive other alternatives for assembling the extrusion die. In some embodiments, the at least one end block has an inlet port for introduction of fluid material into one or both of the cavities.

In some embodiments, the shims will be assembled according to a plan that provides a repeating sequence of shims of diverse types. The repeating sequence can have two or more shims per repeat. For a first example, a two-shim repeating sequence could comprise a shim that provides a conduit between the first cavity and a first dispensing orifice and a shim that provides a conduit between the second cavity and a dispensing orifice. For a second example, a four-shim repeating sequence could comprise a shim that provides a conduit between the first cavity and a dispensing orifice, a spacer shim, a shim that provides a conduit between the second cavity and a second dispensing orifice, and a spacer shim.

Exemplary passageway cross-sectional shapes include square, and rectangular shapes. The shape of the passageways within, for example, a repeating sequence of shims, may be identical or different. For example, in some embodiments, the shims that provide a passageway between the first cavity and a first dispensing orifice might have a flow restriction compared to the shims that provide a conduit between the second cavity and a second dispensing orifice. The width of the distal opening within, for example, a repeating sequence of shims, may be identical or different. For example, the portion of the distal opening provided by the shims that provide a conduit between the first cavity and a first dispensing orifice could be narrower than the portion of the distal opening provided by the shims that provide a conduit between the second cavity and a second dispensing orifice.

The shape of a dispensing orifice within, for example, a repeating sequence of shims, may be identical or different. For example a 4-shim repeating sequence could be employed having a shim that provides a conduit between the first cavity and first dispensing orifice, a spacer shim, a shim that provides a conduit between the second cavity and a second dispensing orifice slot, and a spacer shim, wherein the shims that provide a conduit between the second cavity and a second dispensing orifice have a narrowed passage displaced from both edges of the distal opening.

In some embodiments, the assembled shims (conveniently bolted between the end blocks) further comprise a manifold body for supporting the shims. The manifold body has at least one (or more (e.g., two or three, four, or more)) manifold therein, the manifold having an outlet. An expansion seal (e.g., made of copper or alloys thereof) is disposed so as to seal the manifold body and the shims, such that the expansion seal defines a portion of at least one of the cavities (in some embodiments, a portion of both the first and second cavities), and such that the expansion seal allows a conduit between the manifold and the cavity.

In some embodiments, with respect to extrusion dies described herein, each of the dispensing orifices of the first and the second arrays have a width, and each of the dispensing orifices of the first and the second arrays are separated by up to 2 times the width of the respective dispensing orifice.

Typically, the passageway between cavity and dispensing orifice is up to 5 mm in length. Typically, the first array of fluid passageways has greater fluid restriction than the second array of fluid passageways.

In some embodiments, for extrusion dies described herein, each of the dispensing orifices of the first and the second arrays have a cross sectional area, and each of the dispensing orifices of the first arrays has an area different than that of the second array.

In accordance with another aspect of the present disclosure, a method of making a netting or array described herein is provided, the method comprising one of Method I or Method II:

Method I

providing an extrusion die comprising a plurality of shims positioned adjacent to one another, the shims together defining a cavity, the extrusion die having a plurality of first dispensing orifices in fluid communication with the cavity and a plurality of second dispensing orifices in fluid communication with the cavity, such that the first and second dispensing orifices are alternated; and

dispensing first polymeric strands from the first dispensing orifices at a first strand speed while simultaneously dispensing second polymeric strands from the second dispensing orifices at a second strand speed, wherein the first strand speed is at least 2 (in some embodiments, in a range from 2 to 6, or even 2 to 4) times the second strand speed to provide the netting (i.e., the first and second dispensing orifices in fluid communication with the (single) cavity such that in use the first and second strand speeds are sufficiently different to produce net bonding); or

Method II

providing an extrusion die comprising a plurality of shims positioned adjacent to one another, the shims together defining a first cavity and a second cavity, the extrusion die having a plurality of first dispensing orifices in fluid communication with the first cavity and having a plurality of second dispensing orifices connected to the second cavity, such that the first and second dispensing orifices are alternated; and dispensing first polymeric strands from the first dispensing orifices at a first strand speed while simultaneously dispensing second polymeric strands from the second dispensing orifices at a second strand speed, wherein the first strand speed is at least 2 (in some embodiments, in a range from 2 to 6, or even 2 to 4) times the second strand speed to provide the netting. In some embodiments, the plurality of shims comprises a plurality of a repeating sequence of shims that includes a shim that provides a passageway between the first cavity and at least one of the first dispensing orifices and a shim that provides a passageway between the second cavity and the at least one of the second dispensing orifices. In some embodiments, the polymers of the first and second polymeric strands are the same, while in others they are different.

In some embodiments, a cavity of an extrusion die described herein is supplied with a first polymer at a first pressure so as to dispense a first strand at a first strand speed through a first passageway, and to dispense a second strand at a second strand speed through a second passageway, wherein the first strand speed is at least 2 (in some embodiments, 2 to 6, or even 2 to 4) times the second strand speed, such that a netting comprising an array of alternating first and second polymeric strands is formed. In some embodiments, the first and second polymers are the same, while in others they are different.

In some embodiments, the first cavity of an extrusion die described herein is supplied with a first polymer at a first pressure so as to dispense the first polymer from the first array at a first strand speed, the second cavity of an extrusion die described herein is supplied with a second polymer at a second pressure so as to dispense the second polymer from the second array at a second strand speed, wherein the first strand speed is at least 2 (in some embodiments, 2 to 6, or even 2 to 4) times the second strand speed, such that a netting comprising an array of alternating first and second polymeric strands is formed. In some embodiments, the first and second polymers are the same, while in others they are different.

Typically, the spacing between orifices is up to 2 times the width of the orifice. The spacing between orifices is greater than the resultant diameter of the strand after extrusion. This diameter is commonly called die swell. This spacing between orifices is greater than the resultant diameter of the strand after extrusion leads to the strands repeatedly colliding with each other to form the repeating bonds of the netting. If the spacing between orifices is too great the strands will not collide with each other and will not form the netting.

The shims for dies described herein typically have thicknesses in the range from 50 micrometers to 125 micrometers, although thicknesses outside of this range may also be useful. Typically, the fluid passageways have thicknesses in a range from 50 micrometers to 750 micrometers, and lengths less than 5 mm (with generally a preference for smaller lengths for decreasingly smaller passageway thicknesses), although thicknesses and lengths outside of these ranges may also be useful. For large diameter fluid passageways several smaller thickness shims may be stacked together, or single shims of the desired passageway width may be used.

The shims are tightly compressed to prevent gaps between the shims and polymer leakage. For example, 12 mm (0.5 inch) diameter bolts are typically used and tightened, at the extrusion temperature, to their recommended torque rating. Also, the shims are aligned to provide uniform extrusion out the extrusion orifice, as misalignment can lead to strands extruding at an angle out of the die which inhibits desired bonding of the net. To aid in alignment, an alignment key can be cut into the shims. Also, a vibrating table can be useful to provide a smooth surface alignment of the extrusion tip.

The size (same or different) of the strands can be adjusted, for example, by the composition of the extruded polymers, velocity of the extruded strands, and/or the orifice design (e.g., cross sectional area (e.g., height and/or width of the orifices)). For example, a first polymer orifice that is 3 times greater in area than the second polymer orifice can generate a net with equal strand sizes while meeting the velocity difference between adjacent strands.

In general, it has been observed that the rate of strand bonding is proportional to the extrusion speed of the faster strand. Further, it has been observed that this bonding rate can be increased, for example, by increasing the polymer flow rate for a given orifice size, or by decreasing the orifice area for a given polymer flow rate. It has also been observed that the distance between bonds (i.e., strand pitch) is inversely proportional to the rate of strand bonding, and proportional to the speed that the netting is drawn away from the die. Thus, it is believed that the bond pitch and the net basis weight can be independently controlled by design of the orifice cross sectional area, the takeaway speed, and the extrusion rate of the polymer. For example, relatively high basis weight nettings, with a relatively short bond pitch can be made by extruding at a relatively high polymer flow rate, with a relatively low netting takeaway speed, using a die with a relatively small strand orifice area.

Typically, the polymeric strands are extruded in the direction of gravity. This enables collinear strands to collide with each other before becoming out of alignment with each other. In some embodiments, it is desirable to extrude the strands horizontally, especially when the extrusion orifices of the first and second polymer are not collinear with each other.

In practicing the method, the first and second polymeric materials, which can be the same of different, might be solidified simply by cooling. This can be conveniently accomplished passively by ambient air, or actively by, for example, quenching the extruded first and second polymeric materials on a chilled surface (e.g., a chilled roll). In some embodiments, the first and/or second polymeric materials are low molecular weight polymers that need to be cross-linked to be solidified, which can be done, for example, by electromagnetic or particle radiation. In some embodiments, it is desirable to maximize the time to quenching to increase the bond strength.

Optionally, it may be desirable to stretch the as-made netting. Stretching may orientate the strands, and has been observed to increase the tensile strength properties of the netting. Stretching may also reduce the overall strand size, which may be desirable for applications which benefit from a relatively low basis weight. As an additional example, if the materials and the degree of stretch, are chosen correctly, the stretch can cause some of the strands to yield while others do not, tending to form loft (e.g., the loft may be created because of the length difference between adjacent bonded net strands or by curling of the bonds due to the yield properties of the strands forming the bond). Optionally, both strands may be stretched beyond their respective yields and upon recovery, the first strands recover more than the second strands. The attribute can be useful for packaging applications where the material can be shipped to package assembly in a relatively dense form, and then lofted, on location. The loftiness attribute can also be useful as the loop for hook and loop attachment systems, wherein the loft created with strands enables hook attachment to the netting strands.

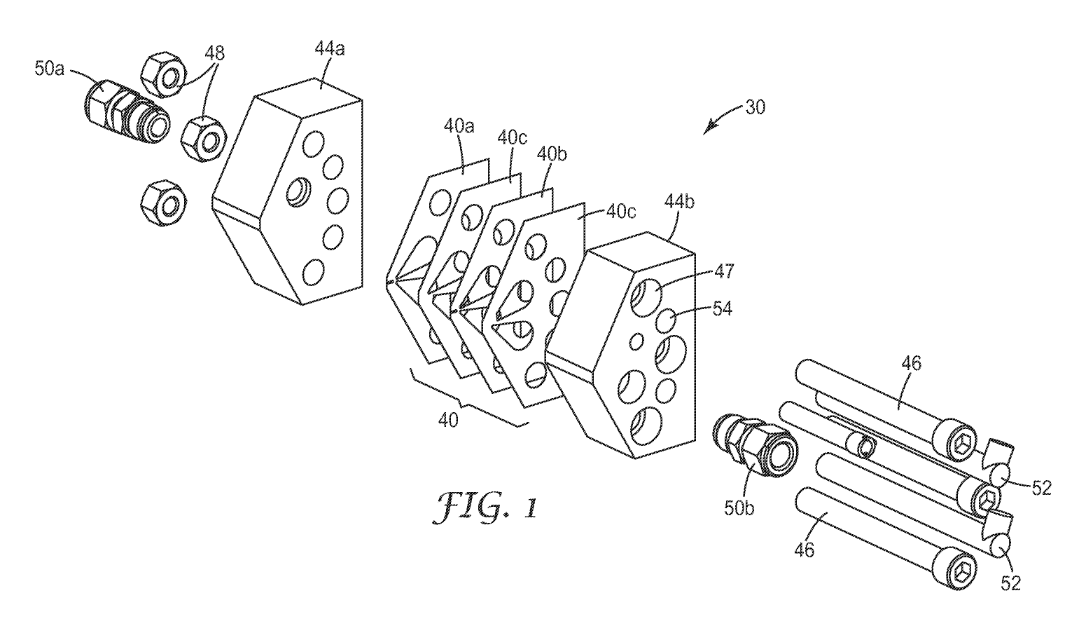

Referring to FIG. 1, an exploded view of an exemplary embodiment of an extrusion die 30 according to the present disclosure is illustrated. Extrusion die 30 includes plurality of shims 40. In some embodiments of extrusion dies described herein, there will be a large number of very thin shims 40 (typically several thousand shims; in some embodiments, at least 1000, 2000, 3000, 4000, 5000, 6000, 7000, 8000, 9000, or even at least 10,000), of diverse types (shims 40a, 40b, and 40c), compressed between two end blocks 44a and 44b. Conveniently, fasteners (e.g., through bolts 46 threaded onto nuts 48) are used to assemble the components for extrusion die 30 by passing through holes 47. Inlet fittings 50a and 50b are provided on end blocks 44a and 44b respectively to introduce the materials to be extruded into extrusion die 30. In some embodiments, inlet fittings 50a and 50b are connected to melt trains of conventional type. In some embodiments, cartridge heaters 52 are inserted into receptacles 54 in extrusion die 30 to maintain the materials to be extruded at a desirable temperature while in the die.

Referring now to FIG. 2, a plan view of shim 40a from FIG. 1 is illustrated. Shim 40a has first aperture 60a and second aperture 60b. When extrusion die 30 is assembled, first apertures 60a in shims 40 together define at least a portion of first cavity 62a. Similarly, second apertures 60b in shims 40 together define at least a portion of second cavity 62b. Material to be extruded conveniently enters first cavity 62a via inlet port 50a, while material to be extruded conveniently enters second cavity 62b via inlet port 50b. Shim 40a has a duct 64 ending in a first dispensing orifice 66a in a dispensing surface 67. Shim 40a further has a passageway 68a affording a conduit between first cavity 62a and duct 64. In carrying out the method of the present invention, the dimensions of the duct 64, and especially the first dispensing orifice 66a at its end, is constrained by the dimensions desired in the polymer strands extruded from them. Since the strand speed of the strand emerging from the first dispensing orifice 66a is also of significance, manipulation of the pressure in cavity 62a and the dimensions of passageway 68a are used to set the desired strand speed. In the embodiment of FIG. 1, shim 40b is a reflection of shim 40a, having a passageway instead affording a conduit between second cavity 62b and second dispensing orifice 66b.

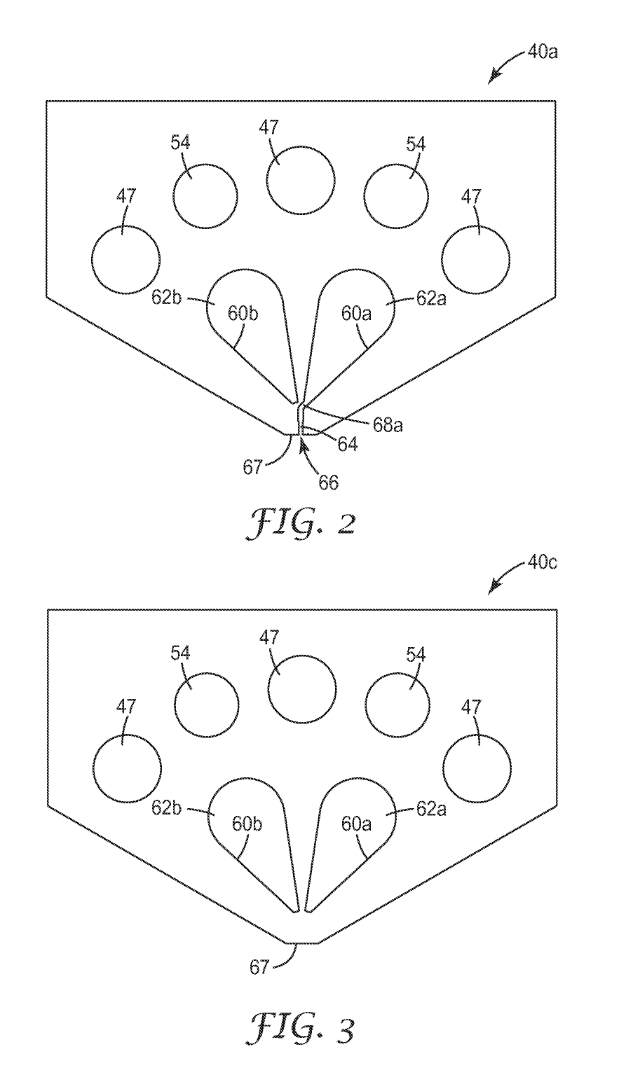

Referring now to FIG. 3, a plan view of shim 40c from FIG. 1 is illustrated. Shim 40c has no passageway between either of first or second cavities 62a and 62b, respectively, and no duct opening onto dispensing surface 67.

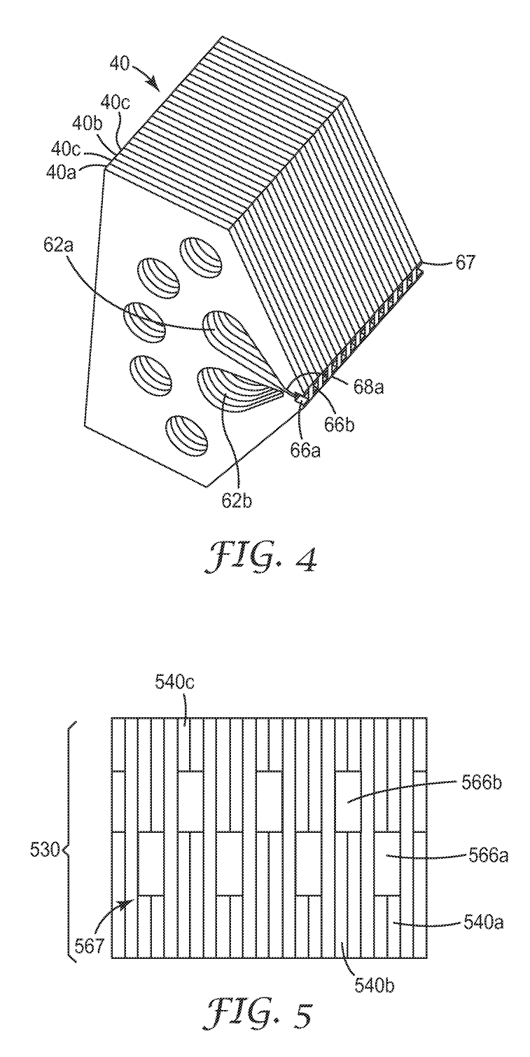

Referring now to FIG. 4, a perspective partial cutaway detail view of plurality of shims 40 packed closely together and ready to be assembled into die 30 of FIG. 1. Specifically, plurality of shims 40 conveniently form a repeating sequence of four shims. First in the sequence from left to right as the view is oriented is shim 40a. In this view, passageway 68a, which leads from cavity 62a to first dispensing orifice 66a in dispensing surface 67, can be seen. Second in the sequence is spacer shim 40c. Third in the sequence is shim 40b, which is simply shim 40a turned upside down so there is a passageway (not seen in this FIG.) between cavity 62b and second dispensing orifices 66b in dispensing surface 67. Fourth in the sequence is second spacer shim 40c. When complete die 30 is assembled with shims of this type in this way, and two flowable polymer containing compositions are introduced under pressure to cavities 62a and 62b, first and second polymeric strands respectively will emerge from first and second dispensing orifices 66a and 66b, supplied by cavities 62a and 62b. If the first polymeric strands have a first strand speed that is in a range from 2 to 6 (or even 2 to 4) times the second strand speed of the second polymeric strands, a net can be produced.

It will be observed that the dispensing orifices 66a and 66b are alternating and collinear. This second feature is not a requirement of the invention, and this is illustrated in FIG. 5. Referring now to FIG. 5, a front close up view of a portion of the dispensing surface 567 of alternately assembled die 530 is illustrated. This assembly also comprises a repeating sequence of shims, each repeat having six shims. First in the sequence, from right to left, are two shims 540a, one shim 540c, two shims 540b, and one shim 540c. Although not visualized in FIG. 5, shims 540a have passageways analogous to passageways 68a, leading backwards and upwards as the drawing is oriented, together providing a fluid conduit with first cavity analogous to 62a. Next in the sequence is one spacer shim 540c, which in this arrangement still helps define the first dispensing orifice 566a on its left and the second dispensing orifice 566b on its right. Next in the sequence are two shims 540b. Although not visualized in FIG. 5, shims 540b have passageways analogous to passageways 68b, leading backwards and downwards as the drawing is oriented, together providing a fluid conduit with second cavity analogous to second cavity 62b. Although the first dispensing orifices 566a are collinear with each other, and the second dispensing orifices 566b are collinear with each other, they are offset from the first dispensing orifices 566a.

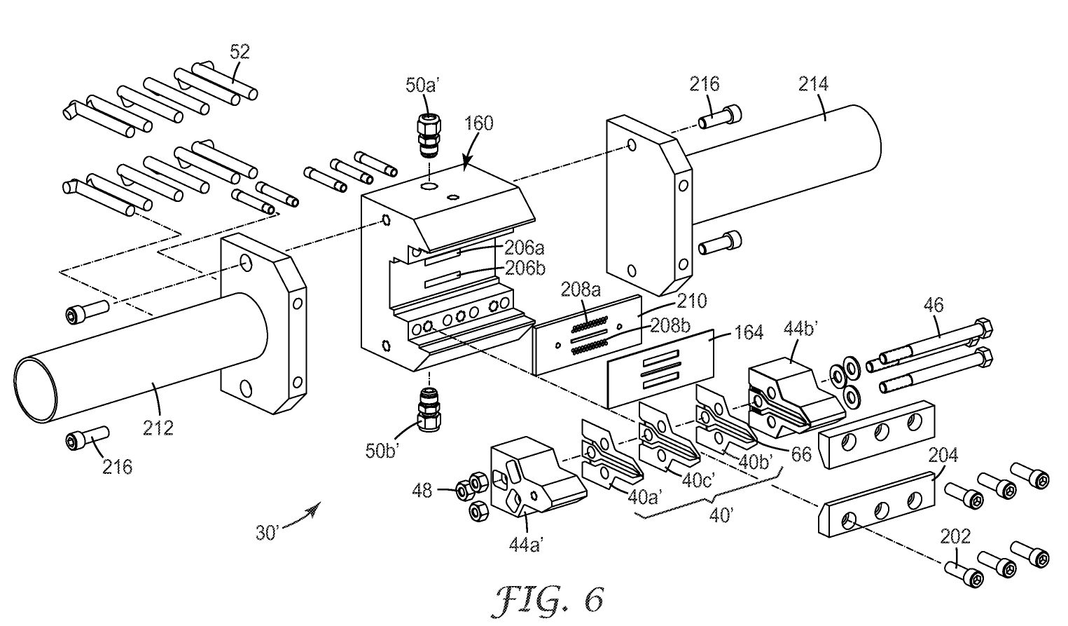

Referring now to FIG. 6, a perspective exploded view of an alternate embodiment of extrusion die 30′ according to the present disclosure is illustrated. Extrusion die 30′ includes plurality of shims 40′. In the depicted embodiment, there are a large number of very thin shims 40′, of diverse types (shims 40a′, 40b′, and 40c′), compressed between two end blocks 44a′ and 44b′. Conveniently, through bolts 46 and nuts 48 are used to assemble the shims 40′ to the end blocks 44a′ and 44b′.

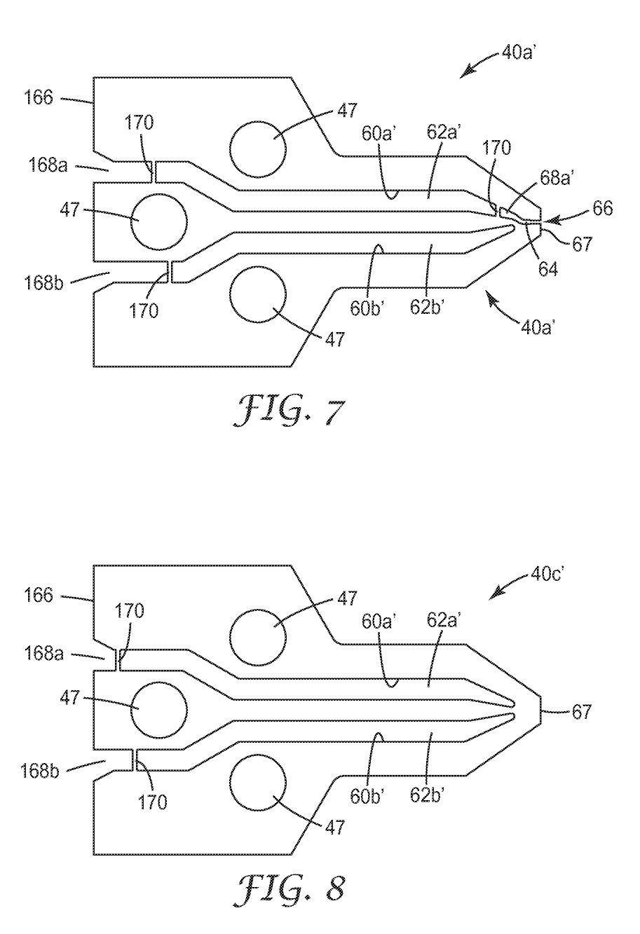

In this embodiment, the end blocks 44a′ and 44b′ are fastened to manifold body 160, by bolts 202 pressing compression blocks 204 against the shims 40′ and the end blocks 44a′ and 44b′. Inlet fittings 50a′ and 50b′ are also attached to manifold body 160. These are in a conduit with two internal manifolds, of which only the exits 206a and 206b are visible in FIG. 6. Molten polymeric material separately entering body 160 via inlet fittings 50a′ and 50b′ pass through the internal manifolds, out the exits 206a and 206b, through passages 208a and 208b in alignment plate 210 and into openings 168a and 168b (seen in FIG. 7).

An expansion seal 164 is disposed between the shims 40′ and the alignment plate 210. Expansion seal 164, along with the shims 40′ together define the volume of the first and the second cavities (62a′ and 62b′ in FIG. 7). The expansion seal withstands the high temperatures involved in extruding molten polymer, and seals against the possibly slightly uneven rear surface of the assembled shims 40′. Expansion seal 164 may made from copper, which has a higher thermal expansion constant than the stainless steel conveniently used for both the shims 40′ and the manifold body 160. Another useful expansion seal 164 material includes a polytetrafluoroethylene (PTFE) gasket with silica filler (available, for example, from Garlock Sealing Technologies, Palmyra, N.Y., under the trade designation “GYLON 3500” and “GYLON 3545”).

Cartridge heaters 52 may be inserted into body 160, conveniently into receptacles in the back of manifold body 160 analogous to receptacles 54 in FIG. 1. It is an advantage of the embodiment of FIG. 6 that the cartridge heaters are inserted in the direction perpendicular to slot 66, in that it facilitates heating the die differentially across its width. Manifold body 160 is conveniently gripped for mounting by supports 212 and 214, and is conveniently attached to manifold body 160 by bolts 216.

Referring now to FIG. 7, a plan view of shim 40a′ from FIG. 6 is illustrated. Shim 40a′ has first aperture 60a′ and second aperture 60b′. When extrusion die 30′ is assembled, first apertures 60a′ in shims 40′ together define at least a portion of first cavity 62a′. Similarly, second apertures 60b′ in shims 40′ together define at least a portion of second cavity 62b′. Base end 166 of shim 40a′ contacts expansion seal 164 when extrusion die 30′ is assembled. Material to be extruded conveniently enters first cavity 62a′ via apertures in expansion seal 164 and via shim opening 168a. Similarly, material to be extruded conveniently enters first cavity 62a′ via apertures in expansion seal 164 and via shim opening 168a.

Shim 40a′ has duct 64 ending in dispensing orifice 66a in dispensing surface 67. Shim 40a′ further has passageway 68a′ affording a conduit between first cavity 62a′ and duct 64. In the embodiment of FIG. 6, shim 40c′ is a reflection of shim 40a′, having a passageway instead affording a conduit between second cavity 62b′ and die duct 64. It might seem that strength members 170 would block the adjacent cavities and passageways, but this is an illusion—the flow has a route in the perpendicular-to-the-plane-of-the-drawing dimension when extrusion die 30′ is completely assembled. Similarly to the embodiment of FIG. 1, shim 40b′ is a reflection of 40a′, having a passageway instead forming a conduit between second cavity 62b′ and the dispensing orifice.

Referring now to FIG. 8, a plan view of shim 40c′ from FIG. 6 is illustrated. Shim 40c′ has no passageway between either of first or second cavities 62a′ and 62b′, respectively, and no duct opening onto dispensing surface 67.

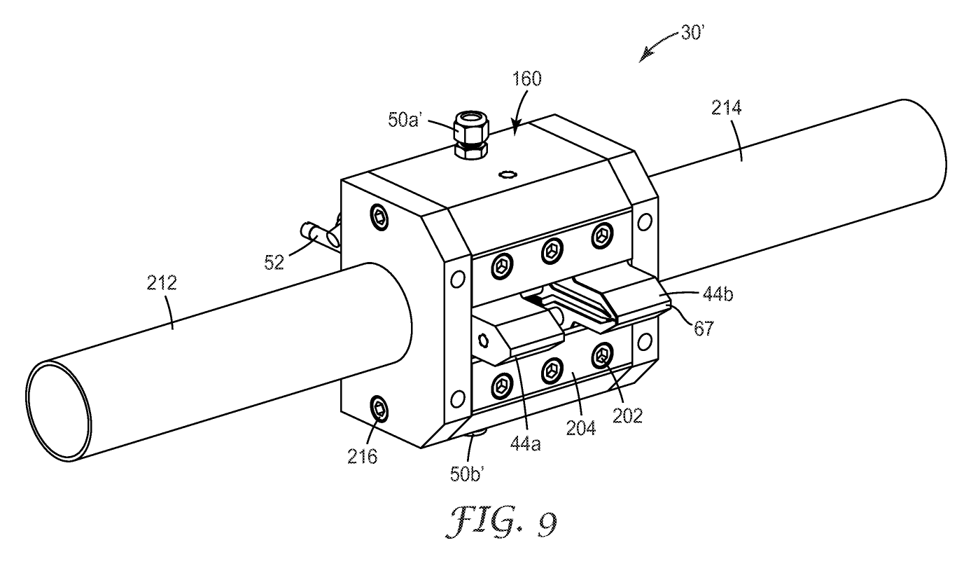

Referring now to FIG. 9, a perspective view of the extrusion die 30′ of FIG. 6 is illustrated in an assembled state, except for most of the shims 40′ which have been omitted to allow the visualization of internal parts. Although the embodiment of FIG. 6 and FIG. 9 is more complicated than the embodiment of FIG. 1, it has several advantages. First, it allows finer control over heating. Second, the use of manifold body 160 allows shims 40′ to be center-fed, increasing side-to-side uniformity in the extruded ribbon region. Third, the forwardly protruding shims 40′ allow dispensing surface 67 to fit into tighter locations on crowded production lines. The shims are typically 0.05 mm (2 mils) to 0.25 mm (10 mils) thick, although other thicknesses, including, for example, those from 0.025 mm (1 mil) to 1 mm (40 mils) may also be useful. Each individual shim is generally of uniform thickness, preferably with less than 0.005 mm (0.2 mil), more preferably, less than 0.0025 mm (0.1 mil) in variability.

The shims are typically metal, preferably stainless steel. To reduce size changes with heat cycling, metal shims are preferably heat-treated.

The shims can be made by conventional techniques, including wire electrical discharge and laser machining. Often, a plurality of shims are made at the same time by stacking a plurality of sheets and then creating the desired openings simultaneously. Variability of the flow channels is preferably within 0.025 mm (1 mil), more preferably, within 0.013 mm (0.5 mil).

Referring now to FIG. 10, a schematic perspective view of a portion of extrusion die 1030 is illustrated, supplied with polymeric material and forming a net. Polymer from first cavity 1062a emerges as first strands 1070a from first dispensing orifices 1066a, and second strands 1070b are emerging from second dispensing orifices 1066b. Passageways 1068a (hidden behind the nearest shim in this view) and 1068b, and the pressures in cavities 1062a and 1062b are selected so that the strand speed of first strands 1070a are between about 2 and 6 times greater than the strand speed of second strands 1040b.

Referring now to FIG. 11, a front view of a portion of dispensing surface 1167 of alternately assembled die 1130 is illustrated. A repeated sequence of shims is present in which the dispensing orifices 1166a and 1166b are alternating and collinear. Each repeat in this comprises a repeating sequence of sixteen shims. First in the sequence are five shims 1140a, then three spacer shims 1140c, then five shims 1140b, then three spacer shims 1140c.

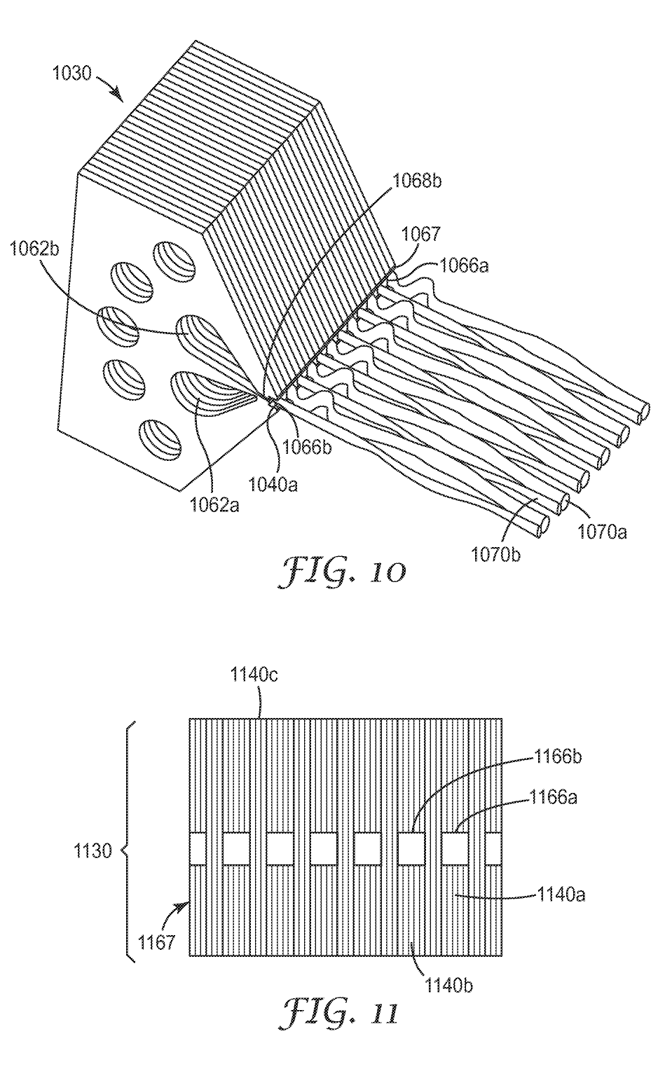

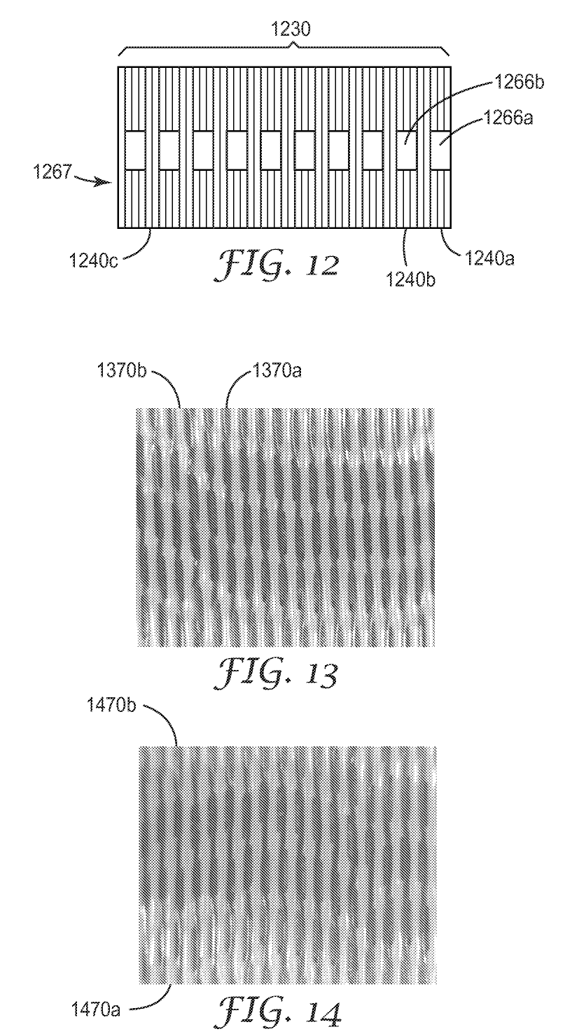

Referring now to FIG. 12, a front view of a portion of dispensing surface 1267 of alternately assembled die 1230 is illustrated. A repeated sequence of shims is present in which the dispensing orifices 1266a and 1266b are alternating and collinear. Each repeat in this comprises a repeating sequence of ten shims. First in the sequence are three shims 1240a, then two spacer shims 1240c, then three shims 1240b, then two spacer shims 1240c.

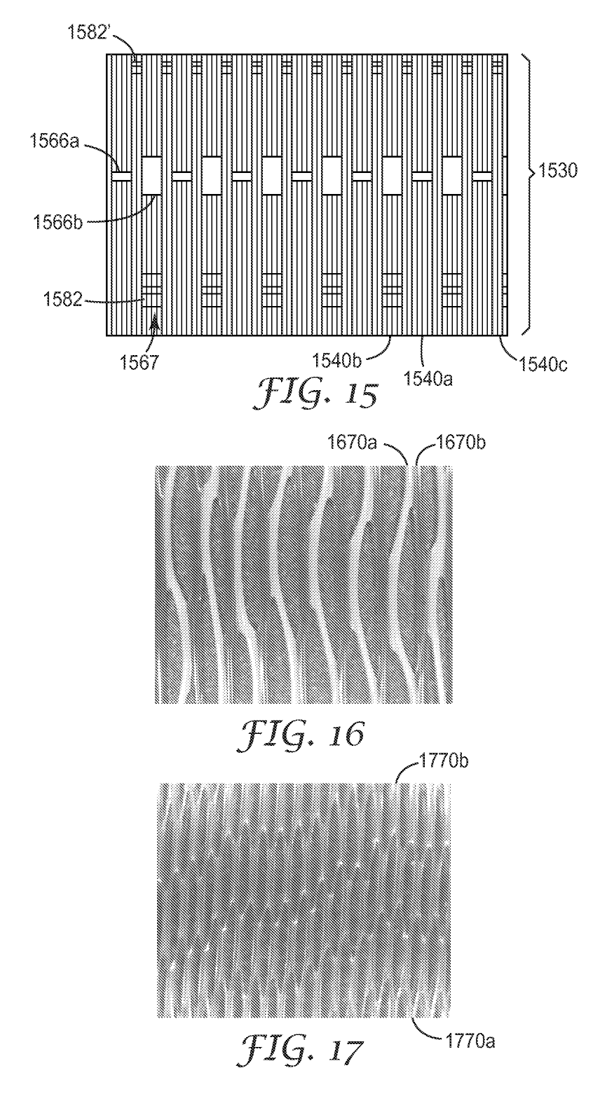

Referring now to FIG. 15, a front view of a portion of dispensing surface 1567 of assembled die 1530 is illustrated. A repeated sequence of shims is present in which dispensing orifices 1566a and 1566b are alternating and collinear. Each repeat in this comprises a repeating sequence of twelve shims. First in the sequence are four shims 1540a, then two spacer shims 1540c, then four shims 1540b, then two spacer shims 1540c. In this embodiment, shims 1540b have an identification notch 1582, and shims 1540c have an identification notch 1582′ to help verify that the die 1530 has been assembled in the desired manner.

Referring now to FIG. 24, a front view of a portion of dispensing surface 2467 of alternately assembled die 2430 is illustrated. A repeated sequence of shims is present in which the dispensing orifices 2466a and 2466b are alternating and collinear. Each repeat in this comprises a repeating sequence of eight shims. First in the sequence are two shims 2440a, then two spacer shims 2440c, then two shims 2440b, then two spacer shims 2440c.

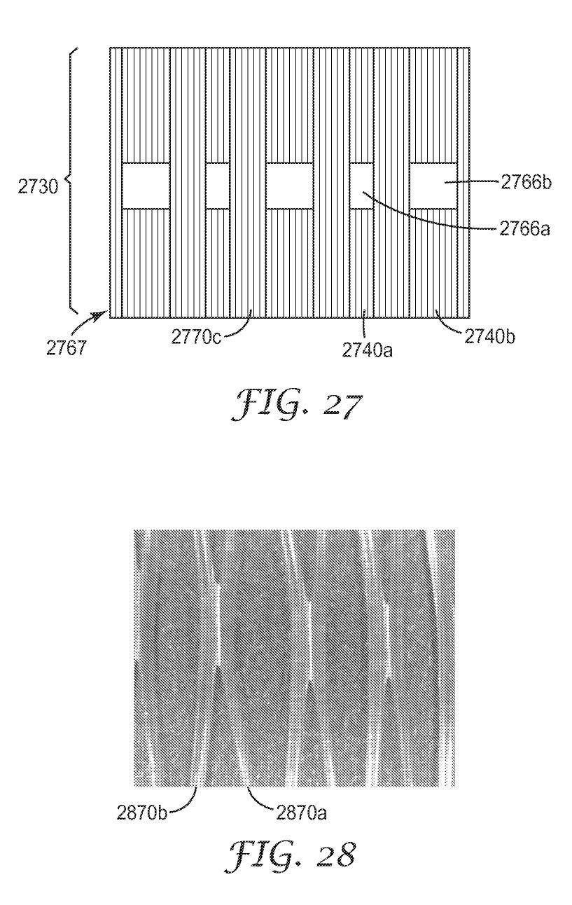

Referring now to FIG. 27, a front view of a portion of dispensing surface 2767 of alternately assembled die 2730 is illustrated. A repeated sequence of shims is present in which the dispensing orifices 2766a and 2766b are alternating and collinear. Each repeat in this comprises a repeating sequence of twenty-two shims. First in the sequence are four shims 2740a, then six spacer shims 2740c, then eight shims 2740b, then six spacer shims 2740c.

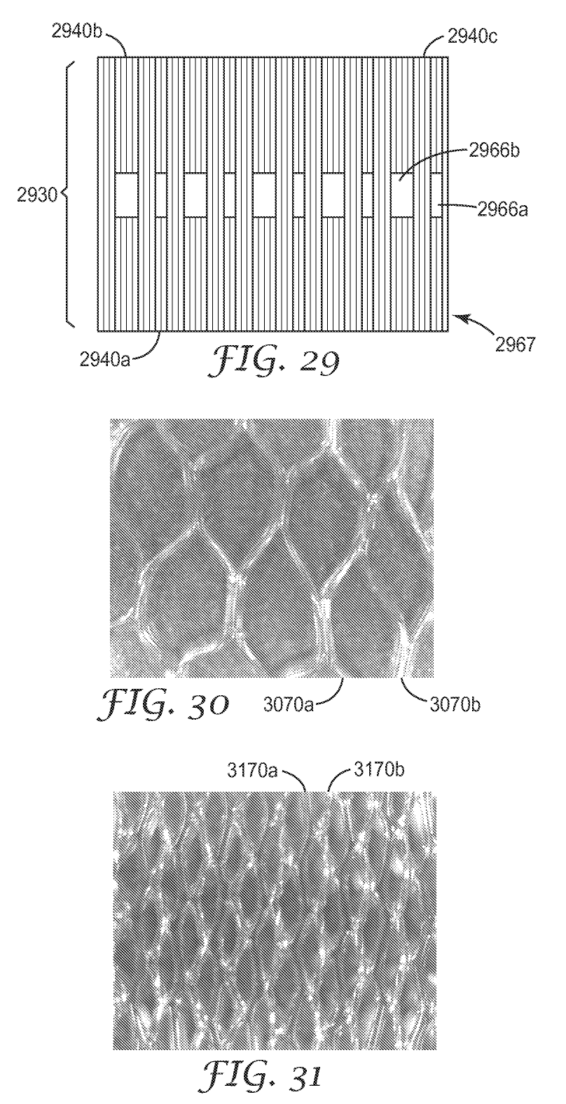

Referring now to FIG. 29, a front view of a portion of dispensing surface 2967 of alternately assembled die 2930 is illustrated. A repeated sequence of shims is present in which the dispensing orifices 2966a and 2966b are alternating and collinear. Each repeat in this comprises a repeating sequence of twelve shims. First in the sequence are two shims 2940a, then three spacer shims 2940c, then four shims 2940b, then three spacer shims 2940c.

Referring now to FIG. 32, a front view of a portion of dispensing surface 3267 of alternately assembled die 3230 is illustrated. A repeated sequence of shims is present in which the dispensing orifices 3266a and 3266b are alternating and collinear. Each repeat in this comprises a repeating sequence of ten shims. First in the sequence are two shims 3240a, then two spacer shims 3240c, then four shims 3240b, then two spacer shims 3240c.

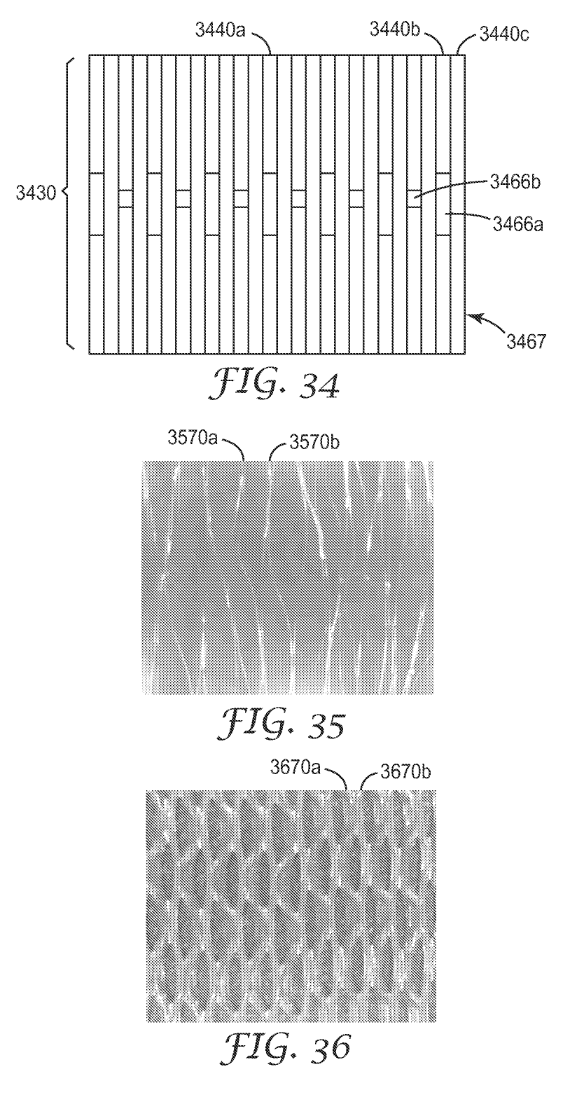

Referring now to FIG. 34, a front view of a portion of dispensing surface 3467 of alternately assembled die 3430 is illustrated. A repeated sequence of shims is present in which the dispensing orifices 3466a and 3466b are alternating and collinear. Each repeat in this comprises a repeating sequence of four shims. First in the sequence is one shim 3440a, then one spacer shim 3440c, then one shim 3440b, then one spacer shim 3440c.

Referring now to FIG. 37, a front view of a portion of dispensing surface 3767 of alternately assembled die 3730 is illustrated. A repeated sequence of shims is present in which the dispensing orifices 3766a and 3766b are alternating and collinear. Each repeat in this comprises a repeating sequence of ten shims. First in the sequence are two shims 3740a, then two spacer shims 3740c, then four shims 3740b, then two spacer shims 3740c. Assembled die 3730 also includes in addition to the repeated sequences a plurality of shims 3740a in zone 3741. This creates slot 3798.

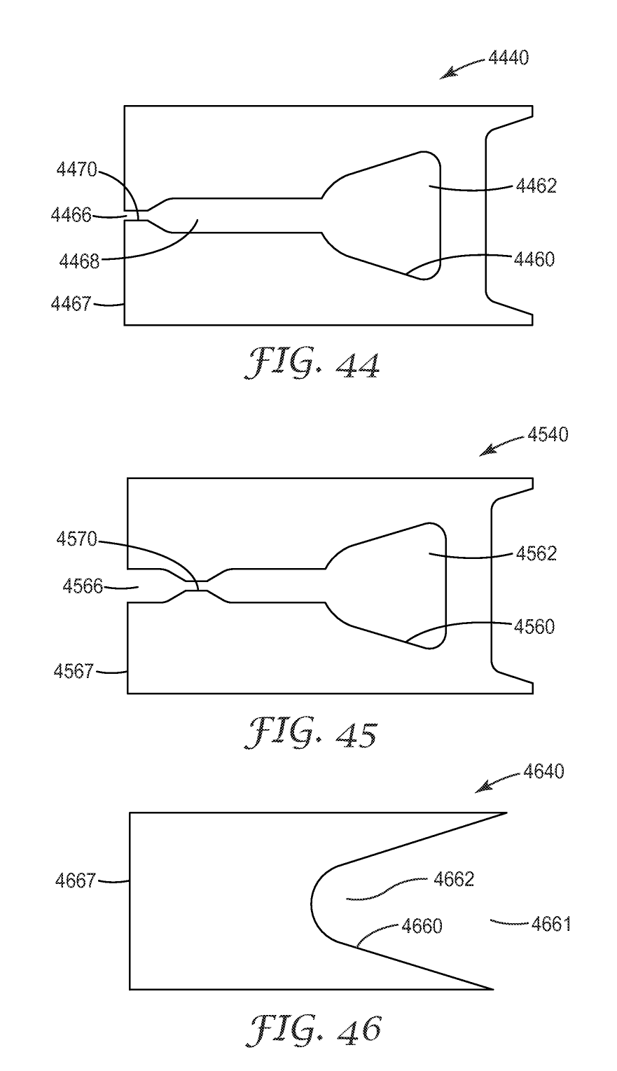

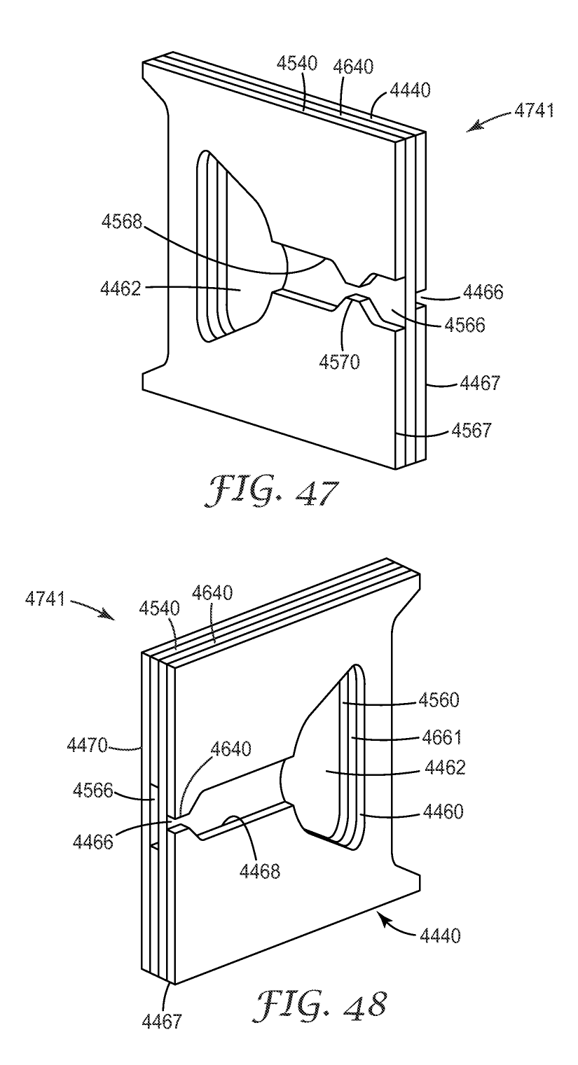

While many convenient embodiments of dies described herein supply the first and second strands from separate first and second cavities, other embodiments are also within the scope of the present disclosure that provide a strand speed difference. For example, referring now to FIG. 44 a plan view of shim 4440, useful in connection with a die for forming netting with first and second strands made from the same material and extruded from a single cavity, is illustrated. Shim 4440 has aperture 4460. When assembled with the shims of FIGS. 45 and 46 in the way described below in FIGS. 47 and 48, aperture 4460 will define at least a portion of cavity 4462. In use, passageway 4468 conducts polymer from cavity 4462 to first dispensing orifice 4466 on dispensing surface 4467. Importantly, there is restriction 4470 adjacent to first dispensing orifice 4466. Restriction 4470 increases the first strand speed of the first strand emerging from first dispensing orifice 4466 during use.

Referring now to FIG. 45, a plan view of shim 4540 is illustrated. Shim 4540 has an aperture 4560. When assembled with the shims of FIGS. 44 and 46 in the way described below in FIGS. 47 and 48, aperture 4560 will define at least a portion of cavity 4462. In use, passageway 4568 conducts polymer from cavity 4462 to second dispensing orifice 4566 on dispensing surface 4567. There is restriction 4570 set back from second dispensing orifice 4566. Restriction 4570 decreases the second strand speed of the second strand emerging from second dispensing orifice 4566 during use.

Referring now to FIG. 46, a plan view of spacer shim 4640 useful in forming netting in conjunction with the shims 4440 and 4540 of FIGS. 44 and 45, is illustrated. Shim 4540 has cut-out 4660. When assembled with the shims of FIGS. 44 and 45 in the way described below in FIGS. 47 and 48, cut-out 4660 will define at least a portion of cavity 4462. Cut-out 4660 has open end 4661 on the end opposite dispensing surface 4667. Open end 4661 allows the inflow of polymer into cavity 4462 when assembled with the other shims and mounted in a die mount analogous to that shown above in FIG. 6.

Referring now to FIG. 47, a detail perspective view of plurality of shims 4741 formed, from left to right, one spacer shim 4640, one shim 4540, one spacer shim 4640, and one shim 4440, is illustrated. In this view it can be appreciated how apertures 4460 and 4560, and cut-out 4660 (not labeled) together define a portion of cavity 4462. It will be apparent to the skilled artisan that for any particular extrusion pressure applied to cavity 4462 during extrusion, the mass flow of the first strand emerging from first dispensing orifice 4466 will be approximately equal to the mass flow of the second strand emerging from second dispensing orifice 4566. However, the first strand speed of the first strand will be significantly faster than the second strand speed of the second strand.

Referring now to FIG. 48, a detail perspective view of the plurality of shims of FIG. 47, seen from the reverse angle, with the nearest instance of shim 4640 removed for visual clarity, is illustrated. In this view of the reduced plurality of shims 4741′, restriction 4570 can be better appreciated.

Polymers used to make netting and arrays of polymeric strands described herein are selected to be compatible with each other such that the first and second strands bond together as the bond regions. In methods described herein for making the nettings and arrays of polymeric strands, the bonding occurs in a relatively short period of time (typically less than 1 second). The bond regions, as well as the strands typically cool through air and natural convection and/or radiation. In selecting polymers for the strands, in some embodiments, it may be desirable to select polymers of bonding strands that have dipole interactions (or H-bonds) or covalent bonds. Bonding between strands has been observed to be improved by increasing the time that the strands are molten to enable more interaction between polymers. Bonding of polymers has generally been observed to be improved by reducing the molecular weight of at least one polymer and or introducing an additional co-monomer to improve polymer interaction and/or reduce the rate or amount of crystallization. In some embodiments, the bond strength is greater than the strength of the strands forming the bond. In some embodiments, it may be desirable for the bonds to break and thus the bonds will be weaker than the strands.

Suitable polymeric materials for extrusion from dies described herein, methods described herein, and for composite layers described herein include thermoplastic resins comprising polyolefins (e.g., polypropylene and polyethylene), polyvinyl chloride, polystyrene, nylons, polyesters (e.g., polyethylene terephthalate) and copolymers and blends thereof. Suitable polymeric materials for extrusion from dies described herein, methods described herein, and for composite layers described herein also include elastomeric materials (e.g., ABA block copolymers, polyurethanes, polyolefin elastomers, polyurethane elastomers, metallocene polyolefin elastomers, polyamide elastomers, ethylene vinyl acetate elastomers, and polyester elastomers). Exemplary adhesives for extrusion from dies described herein, methods described herein, and for composite layers described herein include acrylate copolymer pressure sensitive adhesives, rubber based adhesives (e.g., those based on natural rubber, polyisobutylene, polybutadiene, butyl rubbers, styrene block copolymer rubbers, etc.), adhesives based on silicone polyureas or silicone polyoxamides, polyurethane type adhesives, and poly(vinyl ethyl ether), and copolymers or blends of these. Other desirable materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polyolefins, polyimides, mixtures and/or combinations thereof. Exemplary release materials for extrusion from dies described herein, methods described herein, and for composite layers described herein include silicone-grafted polyolefins such as those described in U.S. Pat. No. 6,465,107 (Kelly) and U.S. Pat. No. 3,471,588 (Kanner et al.), silicone block copolymers such as those described in PCT Publication No. WO96039349, published Dec. 12, 1996, low density polyolefin materials such as those described in U.S. Pat. No. 6,228,449 (Meyer), U.S. Pat. No. 6,348,249 (Meyer), and U.S. Pat. No. 5,948,517 (Meyer), the disclosures of which are incorporated herein by reference.

In some embodiments using first and second polymeric materials to make nettings and arrays of polymeric strands described herein, each have a different modulus (i.e., one relatively higher to the other).

In some embodiments using first and second polymeric materials to make nettings and arrays of polymeric strands described herein, each have a different yield strength.

In some embodiments, polymeric materials used to make nettings and arrays described herein may comprise a colorant (e.g., pigment and/or dye) for functional (e.g., optical effects) and/or aesthetic purposes (e.g., each has different color/shade). Suitable colorants are those known in the art for use in various polymeric materials. Exemplary colors imparted by the colorant include white, black, red, pink, orange, yellow, green, aqua, purple, and blue. In some embodiments, it is desirable level to have a certain degree of opacity for one or more of the polymeric materials. The amount of colorant(s) to be used in specific embodiments can be readily determined by those skilled in the (e.g., to achieve desired color, tone, opacity, transmissivity, etc.). If desired, the polymeric materials may be formulated to have the same or different colors.

In some embodiments, nettings and arrays of polymeric strands described herein have a basis weight in a range from 5 g/m² to 400 g/m² (in some embodiments, 10 g/m² to 200 g/m²), for example, nettings as-made from dies described herein. In some embodiments, nettings described herein after being stretched have a basis weight in a range from 0.5 g/m² to 40 g/m² (in some embodiments, 1 g/m² to 20 g/m²).

In some embodiments, nettings and arrays of polymeric strands described herein have a strand pitch in a range from 0.5 mm to 20 mm (in some embodiments, in a range from 0.5 mm to 10 mm)

Optionally, nettings and arrays of polymeric strands described herein are attached to a backing. The backings may be, for example, one of a film, net, or non-woven. Films may be particularly desirable, for example, for applications utilizing clear printing or graphics. Nonwovens or nets may be particularly desirable, for example, where a softness and quietness that films typically do not have is desired.

In some embodiments, nettings and arrays of polymeric strands described herein are elastic. In some embodiments, nettings and arrays of polymeric strands described herein have a machine direction and a cross-machine direction, wherein the netting or arrays of polymeric strands is elastic in machine direction, and inelastic in the cross-machine direction. Elastic means that the material will substantially resume its original shape after being stretched (i.e., will sustain only small permanent set following deformation and relaxation which set is less than 20 percent (in some embodiments, less than 10 percent) of the original length at moderate elongation (i.e., about 400-500%; in some embodiments, up to 300% to 1200%, or even up to 600 to 800%) elongation at room temperature). The elastic material can be both pure elastomers and blends with an elastomeric phase or content that will still exhibit substantial elastomeric properties at room temperature.

It is within the scope of the instant disclosure to use heat-shrinkable and non-heat shrinkable elastics. Non-heat shrinkable means that the elastomer, when stretched, will substantially recover sustaining only a small permanent set as discussed above.

In some embodiments, arrays described herein of alternating first and second polymeric strands exhibit at least one of diamond-shaped or hexagonal-shaped openings. Long bond lengths, relative to the pitch of the bond in the machine direction, tend to create diamond shaped nets, whereas short bond lengths tend to create hexagon shaped nets.

In some embodiments, the first and second strands have an average width in a range from 10 micrometers to 500 micrometers (in a range from 10 micrometers to 400 micrometers, or even 10 micrometers to 250 micrometers).

In some embodiments, the bond regions have an average largest dimension perpendicular to the strand thickness, wherein the polymeric strands have an average width, and wherein the average largest dimension of the bond regions is at least 2 (in some embodiments, at least 2.5, 3, 3.5, or even at least 4) times greater than the average width of the polymeric strands.

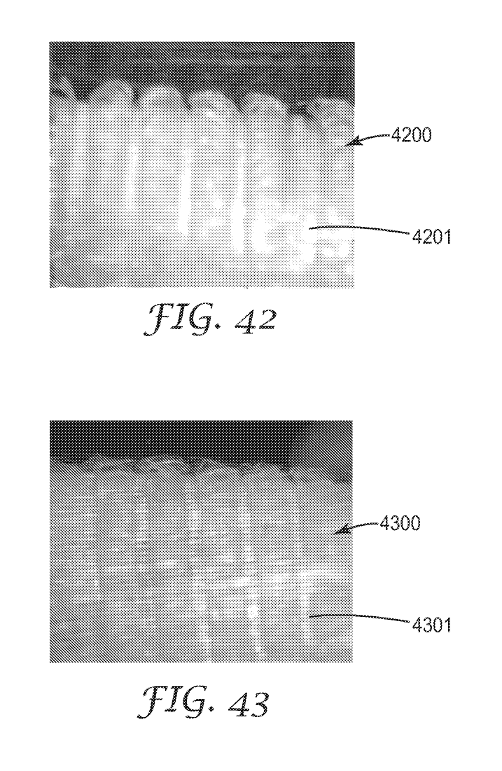

In some embodiments, articles described herein include bond lines as shown, for example, in FIGS. 41 and 42, netting 4100, 4200, respectively, has bond lines 4101, 4201, respectively.

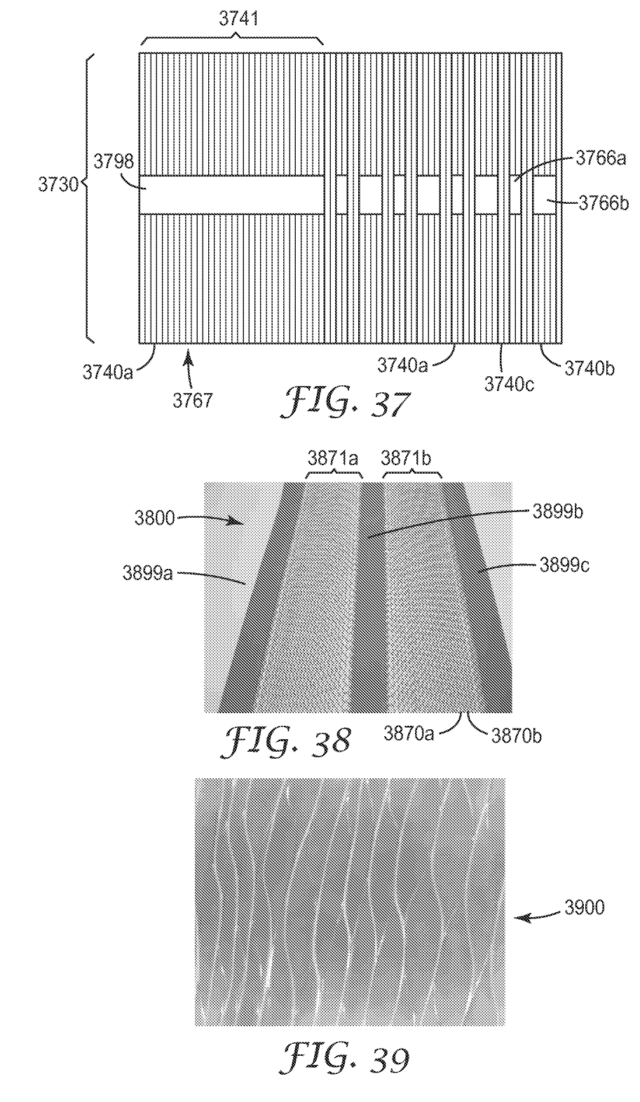

The present disclosure also provides an article comprising two nettings described herein with a ribbon region disposed there between. Typically, the netting and ribbon region are integral. The present disclosure also provides an article comprising netting described herein disposed between two ribbon regions. Typically, the netting and ribbon regions are integral. In some embodiments, the ribbon region has a major surface with engagement posts thereon. An example, without engagements posts, is shown in FIG. 38, where netting 3871a (has first strands 3870a, second strands 3870b) 3871b, ribbon regions 3899a, 3899b, 3899c, attached to netting 3871a, 3871b.

The present disclosure also provides an attachment system comprising netting (optionally additional netting described herein to provide multiple (i.e., 2 or more) layers of netting) described herein and an array of engagement posts (e.g., hooks) for engaging with the netting. Engagement hooks can be made as is known in the art (see, for example, U.S. Pat. No. 5,077,870 (Melbye et al.)).

Nettings and arrays of polymeric strands described herein have a variety of uses, including wound care and other medical applications (e.g., elastic bandage-like material, surface layer for surgical drapes and gowns, and cast padding), tapes (including for medical applications), filtration, absorbent articles (e.g., diapers and feminine hygiene products) (e.g., as a layer(s) within the articles and/or as part of an attachment system for the articles), pest control articles (e.g., mosquito nettings), geotextile applications (e.g., erosion control textiles), water/vapor management in clothing, reinforcement for nonwoven articles (e.g., paper towels), self bulking articles (e.g., for packaging) where the netting thickness is increased by stretching nettings with high and low modulus strands, floor coverings (e.g., rugs and temporary mats), grip supports for tools, athletic articles, etc., and pattern-coated adhesives.

Advantages of some embodiments of nettings described herein when used as a backing, for example, for some tapes and wound dressings can include conformability, particularly in the cross direction (e.g., at least 50% elongation in the machine direction).

In some embodiments, nettings described herein are made of hydrophilic to make them absorbent. In some embodiments, nettings described herein are useful as wound absorbants to remove excess exudate from wounds, and in some embodiments, nettings described herein are made of bioresorbable polymers.

In some filtration applications, the netting can be used, for example, to provide spacers between filtering layers for filtration packs and/or to provide rigidity and support for filtration media. In some embodiments, several layers of the netting are used, where each layer is set to provide optimal filtering. Also, in some embodiments, the elastic feature of some nettings described herein can facilitate expansion of the filter as the filter fills up.

In some embodiments, nettings described herein have high and low modulus strands such that stretching netting having a curled bond area can generate a lofted, accessible fiber for hook attachment (i.e., for an attachment system). In such oriented nettings attachment loops can have fiber strengths that are greater than unoriented nettings.

In some embodiments, nettings described herein that are elastic can flex in the machine direction, cross direction, or both directions, which can provide, for example, comfort and fit for diapers and the like. Elastic netting can also provide a breathable, soft, and flexible attachment mechanism (e.g., elastic netting can be attached to posts that fit through the elastic net, the elastic net can be made with a ribbon region section attached to the netting to provide the fingerlift, the elastic can be made as elastic in one direction and inelastic in the second direction with an elastic and inelastic strand, or the ribbon region can have molded hooks to provide attachment to a loop).

In some embodiments, nettings described herein useful as grip supports for tools, athletic articles, etc. are made using high friction polymers.

In some embodiments, nettings described herein are useful in providing pattern-coated adhesives. For example, an adhesive polymer can be formed as a netting, and then be used as a bonding layer with sealing in the side direction while providing porosity in the thickness direction of the bond. Adhesive nettings can also provide thickness with minimal amount of material usage.

Some embodiments of nettings described herein can be used as or in disposable absorbent articles that may be useful, for example as personal absorbent articles for absorbing bodily fluids (e.g., perspiration, urine, blood, and menses) and disposable household wipes used to clean up similar fluids or typical household spills.

A particular example of a disposable absorbent article comprising nettings described herein are disposable absorbent garments such as infant diapers or training pants, products for adult incontinence, feminine hygiene products (e.g., sanitary napkins and panty liners). A typical disposable absorbent garment of this type is formed as a composite structure including an absorbent assembly disposed between a liquid permeable bodyside liner and a liquid impermeable outer cover. These components can be combined with other materials and features such as elastic materials and containment structures to form a product that is specifically suited to its intended purposes. Feminine hygiene tampons are also well known and generally are constructed of an absorbent assembly and sometimes an outer wrap of a fluid pervious material.

### EXEMPLARY EMBODIMENTS

1A. A netting comprising an array of polymeric strands periodically joined together at bond regions throughout the array, but do not substantially cross over each other (i.e., at least 50 (at least 55, 60, 65, 70, 75, 80, 85, 90, 95, 99, or even 100) percent by number), wherein the netting has a thickness up to 750 micrometers (in some embodiments, up to 500 micrometers, 250 micrometers, 100 micrometers, 75 micrometers, 50 micrometers, or even up to 25 micrometers; in a range from 10 micrometers to 750 micrometers, 10 micrometers to 750 micrometers, 10 micrometers to 500 micrometers, 10 micrometers to 250 micrometers, 10 micrometers to 100 micrometers, 10 micrometers to 75 micrometers, 10 micrometers to 50 micrometers, or even 10 micrometers to 25 micrometers).

2A. The netting of Embodiment 1A having a basis weight in a range from 5 g/m² to 400 g/m² (in some embodiments, 10 g/m² to 200 g/m²).

3A. The netting of Embodiment 1A having a basis weight in a range from 0.5 g/m² to 40 g/m² (in some embodiments, 1 g/m² to 20 g/m²).

4A. The netting of any preceding Embodiment having a strand pitch (i.e., center point-to-center point of adjacent bonds in the machine direction) in a range from 0.5 mm to 20 mm (in some embodiments, in a range from 0.5 mm to 10 mm)

5A. The netting of any preceding Embodiment that is elastic.

6A. The netting of any of Embodiments 1A to 4A having a machine direction and a cross-machine direction, wherein the netting is elastic in machine direction, and inelastic in the cross-machine direction.

7A. The netting of any of Embodiments 1A to 4A having a machine direction and a cross-machine direction, wherein the netting is inelastic in the machine direction, and elastic in the cross-machine direction.

8A. The netting of any preceding Embodiment, wherein at least some of the polymeric stands include at least one of a dye or pigment therein.

9A. The netting of any preceding Embodiment, wherein the array of polymeric strands exhibits at least one of diamond-shaped or hexagonal-shaped openings.

10A. The netting of any preceding Embodiment, wherein at least some of the polymeric strands comprise a first polymer that is a thermoplastic (e.g., adhesives, nylons, polyesters, polyolefins, polyurethanes, elastomers (e.g., styrenic block copolymers), and blends thereof).

11A. The netting of Embodiment 10A, wherein the first polymer is an adhesive material.

12A. The netting of any preceding Embodiment, wherein the plurality of strands include alternating first and second polymeric strands, wherein the second polymeric strands comprise a second polymer.

13A. The netting of Embodiment 12A, wherein the wherein the first polymeric strands comprise the first polymer, and wherein the second polymeric strands comprise a second polymer that is a thermoplastic (e.g., adhesives, nylons, polyesters, polyolefins, polyurethanes, elastomers (e.g., styrenic block copolymers), and blends thereof).

14A. The netting of either of Embodiments 12A or 13A, wherein the first strands have an average width in a range from 10 micrometers to 500 micrometers (in a range from 10 micrometers to 400 micrometers, or even 10 micrometers to 250 micrometers).

15A. The netting of any of Embodiments 12A to 14A, wherein the second strands have an average width in a range from 10 micrometers to 500 micrometers (in a range from 10 micrometers to 400 micrometers, or even 10 micrometers to 250 micrometers).

16A. The netting of any of Embodiments 12A to 15A further comprising third strands disposed between at least some of the alternating first and second strands.

17A. The netting of any preceding Embodiment where the netting is stretched.

18A. The netting of any preceding Embodiment, wherein the bond regions have an average largest dimension perpendicular to the strand thickness, wherein the polymeric strands have an average width, and wherein the average largest dimension of the bond regions is at least 2 (in some embodiments, at least 2.5, 3, 3.5, or even at least 4) times greater than the average width of the polymeric strands.

19A. An article comprising a backing having the netting of any preceding Embodiment on a major surface thereof.

20A. The article of Embodiment 19A, wherein the backing is one of a film, net, or non-woven.

21A. The article of Embodiment 20A that includes bond lines.

22A. An article comprising the netting of any of Embodiment 1A to 18A disposed between two non-woven layers.

23A. An article comprising two nettings of any of Embodiments 1A to 20A with a ribbon region disposed there between.

24A. The article of Embodiment 23A, wherein the netting and ribbon region are integral.

25A. The article of either Embodiment 23A or 24A, wherein the ribbon region has a major surface with engagement posts thereon.

26A. An article comprising the netting of any of Embodiments 1A to 18A disposed between two ribbon regions.

27A. The article of Embodiment 26A, wherein the netting is integral with each of the ribbon regions.

28A. The article of either Embodiment 26A or 27A, wherein the ribbon has a major surface with engagement posts thereon.

29A. An attachment system comprising the netting of any of Embodiments 1A to 18A and an array of engagement posts (e.g., hooks) for engaging with the netting.

30A. An absorbent article comprising the attachment system of Embodiment 29A.

31A. A method of making the netting of any of Embodiments 1A to 18A, the method comprising one of Method I or Method II:

Method I

providing an extrusion die comprising a plurality of shims positioned adjacent to one another, the shims together defining a cavity, the extrusion die having a plurality of first dispensing orifices in fluid communication with the cavity and a plurality of second dispensing orifices in fluid communication with the cavity, such that the first and second dispensing orifices are alternated; and

dispensing first polymeric strands from the first dispensing orifices at a first strand speed while simultaneously dispensing second polymeric strands from the second dispensing orifices at a second strand speed, wherein the first strand speed is at least 2 (in some embodiments, in a range from 2 to 6, or even 2 to 4) times the second strand speed to provide the netting (i.e., the first and second dispensing orifices in fluid communication with the (single) cavity such that in use the first and second strand speeds are sufficiently different to produce net bonding); or

Method II

providing an extrusion die comprising a plurality of shims positioned adjacent to one another, the shims together defining a first cavity and a second cavity, the extrusion die having a plurality of first dispensing orifices in fluid communication with the first cavity and having a plurality of second dispensing orifices connected to the second cavity, such that the first and second dispensing orifices are alternated; and

dispensing first polymeric strands from the first dispensing orifices at a first strand speed while simultaneously dispensing second polymeric strands from the second dispensing orifices at a second strand speed, wherein the first strand speed is at least 2 (in some embodiments, in a range from 2 to 6, or even 2 to 4) times the second strand speed to provide the netting.

32A. The method of Embodiment 30A, wherein the plurality of shims of either method comprises a plurality of a repeating sequence of shims that includes a shim that provides a passageway between the first cavity and at least one of the first dispensing orifices and a shim that provides a passageway between the second cavity and the at least one of the second dispensing orifices.

33A. The method of either Embodiments 31A or 32A, wherein the repeating sequence of either method further comprises at least one spacer shim.

34A. The method of any of Embodiments 31A to 33A of either method comprising at least 1000 of the shims.

35A. The method of any of Embodiments 31A to 34A, wherein the first dispensing orifices and the second dispensing orifices of either method are collinear.

36A. The method of any of Embodiments 31A to 35A, wherein for either method, the first dispensing orifices are collinear, and the second dispensing orifices are collinear but offset from the first dispensing orifices.

1B. An extrusion die comprising one of:

(I)

a plurality of shims positioned adjacent to one another, the shims together defining a cavity and a dispensing surface, wherein the dispensing surface has an array of first dispensing orifices alternating with an array of second dispensing orifices, wherein the plurality of shims comprises a plurality of a repeating sequence of shims comprising a shim that provides a fluid passageway between the cavity and the first dispensing orifices and a shim that provides a fluid passageway between the cavity and the second dispensing orifices where the first array of fluid passageways has greater fluid restriction than the second array of fluid passageways; or

(II)

a plurality of shims positioned adjacent to one another, the shims together defining a first cavity, a second cavity, and a dispensing surface, wherein the dispensing surface has an array of first dispensing orifices alternating with an array of second dispensing orifices, wherein the plurality of shims comprises a plurality of a repeating sequence of shims comprising a shim that provides a fluid passageway between the first cavity and one of the first dispensing orifices and a shim that provides a fluid passageway between the second cavity and one of second the dispensing orifices.

2B. The extrusion die of Embodiment 1B, wherein for either I or II, the repeating sequence further comprises at least one spacer shim.

3B. The extrusion die of either Embodiment 1B or 2B comprising at least 1000 of the shims for either I or II.

4B. The extrusion die of any of Embodiments 1B to 3B, wherein for either I or II, the first dispensing orifices and the second dispensing orifices are collinear.

5B. The extrusion die of any of Embodiments 1B to 4B, wherein for either I or II, the first dispensing orifices are collinear, and the second dispensing orifices are collinear but offset from the first dispensing orifices.

6B. The extrusion die of any of Embodiments 1B to 5B for either I or II, further comprising a manifold body for supporting the shims, the manifold body having at least one manifold therein, the manifold having an outlet; and further comprising an expansion seal disposed so as to seal the manifold body and the shims, wherein the expansion seal defines a portion of at least one of the cavities, and wherein the expansion seal allows a conduit between the manifold and the cavity.

7B. The extrusion die of any of Embodiment 6B, wherein for either I or II, the expansion seal defines a portion of both the first and the second cavities.

8B. The extrusion die of any of Embodiment 7B, wherein the expansion seal is made of copper.

9B. The extrusion die of any of Embodiments 1B to 8B, further comprising a pair of end blocks for supporting the plurality of shims for either I or II.

10B. The extrusion die of any of Embodiment 9B, wherein for either I or II, each of the shims has at least one through-hole for the passage of connectors between the pair of end blocks.

11B. The extrusion die of any of Embodiments 1B to 10B, wherein for either I or II, each of the dispensing orifices of the first and the second arrays have a width, and wherein each of the dispensing orifices of the first and the second arrays are separated by up to 2 times the width of the respective dispensing orifice.

12B. The extrusion die of any of Embodiments 1B to 11B, for either I or II, wherein the first cavity is supplied with a first polymer at a first pressure so as to dispense the first polymer from the first array at a first strand speed, wherein the second cavity is supplied with a second polymer at a second pressure so as to dispense the second polymer from the second array at a second strand speed, and wherein the first strand speed is between about 2 to 6 times the second strand speed, such that a netting comprising an array of alternating first and second polymeric strands is formed.

13B. The extrusion die of any of Embodiments 1B to 12B, wherein for either I or II, the fluid passageway is up to 5 mm in length.

1C. An extrusion die comprising one of:

(I)

a plurality of shims positioned adjacent to one another, the shims together defining a cavity and a dispensing surface, wherein the dispensing surface has at least one net-forming zone and at least one film-forming zone, wherein the net-forming zone has an array of first dispensing orifices alternating with an array of second dispensing orifices; or

(II)

a plurality of shims positioned adjacent to one another, the shims together defining a first cavity, a second cavity, and a dispensing surface, wherein the dispensing surface has at least one net-forming zone and at least one film-forming zone, wherein the net-forming zone has an array of first dispensing orifices alternating with an array of second dispensing orifices.

2C. The extrusion die of Embodiment 1C, wherein for either I or II the repeating sequence further comprises at least one spacer shim.

3C. The extrusion die of either Embodiment 1C or 2C comprising at least 1000 of the shims for either I or II.

4C. The extrusion die of any of Embodiments 1C to 3C, wherein for either I or II the first dispensing orifices and the second dispensing orifices are collinear.

5C. The extrusion die of any of Embodiments 1C to 3C, wherein for either I or II, the first dispensing orifices are collinear, and the second dispensing orifices are collinear but offset from the first dispensing orifices.

6C. The extrusion die of any of Embodiments 1C to 5C for either I or II further comprising a manifold body for supporting the shims, the manifold body having at least one manifold therein, the manifold having an outlet; and further comprising an expansion seal disposed so as to seal the manifold body and the shims, wherein the expansion seal defines a portion of at least one of the cavities, and wherein the expansion seal allows a conduit between the manifold and the cavity.

7C. The extrusion die of any of Embodiment 6C, wherein for either I or II the expansion seal defines a portion of both the first and the second cavities.

8C. The extrusion die of any of Embodiment 7C, wherein the expansion seal is made of copper.

9C. The extrusion die of any of Embodiments 1C to 8C, further comprising a pair of end blocks for supporting the plurality of shims for either I or II.

10C. The extrusion die of any of Embodiment 9C, wherein for either I or II each of the shims has at least one through-hole for the passage of connectors between the pair of end blocks.

11C. The extrusion die of any of Embodiments 1C to 10C, for either I or II, wherein the first cavity is supplied with a first polymer at a first pressure so as to dispense the first polymer from the first array at a first strand speed, wherein the second cavity is supplied with a second polymer at a second pressure so as to dispense the second polymer from the second array at a second strand speed, and wherein the first strand speed is between about 2 to 6 times the second strand speed, such that a netting comprising an array of alternating first and second polymeric strands is formed in the net-forming zone, and such that a film attached to the netting is formed in the film-forming zone.

1D. An attachment system comprising a netting and an array of engagement posts (e.g., hooks) for engaging with the netting, the netting comprising an array of polymeric strands periodically joined together at bond regions throughout the array, wherein the netting has a thickness up to 750 micrometers (in some embodiments, up to 500 micrometers, 250 micrometers, 100 micrometers, 75 micrometers, 50 micrometers, or even up to 25 micrometers; in a range from 10 micrometers to 750 micrometers, 10 micrometers to 750 micrometers, 10 micrometers to 500 micrometers, 10 micrometers to 250 micrometers, 10 micrometers to 100 micrometers, 10 micrometers to 75 micrometers, 10 micrometers to 50 micrometers, or even 10 micrometers to 25 micrometers).

2D. The attachment system of Embodiment 1D, wherein the engagement posts are attached to a backing.

3D. The attachment system of Embodiment 2D, wherein the backing is one of a film, net, or non-woven.

4D. The attachment system of any of Embodiments 1D to 3D having a basis weight in a range from 0.5 g/m² to 40 g/m² (in some embodiments, 1 g/m² to 20 g/m²).

5D. The attachment system of any of Embodiments 1D to 4D having a strand pitch in a range from 0.5 mm to 20 mm (in some embodiments, in a range from 0.5 mm to 10 mm)

6D. The attachment system of any of Embodiments 1D to 5D that is elastic.

7D. The attachment system of any of Embodiments 1D to 6D, wherein the netting has a machine direction and a cross-machine direction, wherein the netting is elastic in machine direction, and inelastic in the cross-machine direction.

8D. The attachment system of any of Embodiments 1D to 6D, wherein the netting has a machine direction and a cross-machine direction, wherein the netting is inelastic in machine direction, and elastic in the cross-machine direction.

9D. The attachment system of any of Embodiments 1D to 8D, wherein at least some of the polymeric strands include at least one of a dye or pigment therein.

10D. The attachment system of any of Embodiments 1D to 9D, wherein the array of polymeric strands exhibits at least one of diamond-shaped or hexagonal-shaped openings.

11D. The attachment system of any of Embodiments 1D to 10D, wherein at least some of the polymeric strands comprise a first polymer that is a thermoplastic (e.g., adhesives, nylons, polyesters, polyolefins, polyurethanes, elastomers (e.g., styrenic block copolymers), and blends thereof).

12D. The netting of any of Embodiments 1D to 11D, wherein the plurality of strands include alternating first and second polymeric strands, wherein the second polymeric strands comprise a second polymer.

13D. The attachment system of Embodiment 12D, wherein the first polymeric strands comprise the first polymer, and wherein the second polymeric strands comprise a second polymer that is a thermoplastic (e.g., adhesives, nylons, polyesters, polyolefins, polyurethanes, elastomers (e.g., styrenic block copolymers), and blends thereof).

14D. The attachment system of either Embodiments 12D or 13D, wherein the first strands have an average width in a range from 10 micrometers to 500 micrometers (in a range from 10 micrometers to 400 micrometers, or even 10 micrometers to 250 micrometers).

15D. The attachment system of any of Embodiments 12D to 14D, wherein the second strands have an average width in a range from 10 micrometers to 500 micrometers (in a range from 10 micrometers to 400 micrometers, or even 10 micrometers to 250 micrometers.

16D. The attachment system of any of Embodiments 12D to 15D, wherein the first strands, second strands, and bond regions each have thicknesses that are substantially the same.

17D. The attachment system of any of Embodiments 1D to 16D, wherein the bond regions have an average largest dimension perpendicular to the strand thickness, wherein the polymeric strands have an average width, and wherein the average largest dimension of the bond regions is at least 2 (in some embodiments, at least 2.5, 3, 3.5, or even at least 4) times greater than the average width of the polymeric strands.

18D. The attachment system of any of Embodiments 12D to 17D, wherein the array of the netting further comprises third strands disposed between at least some of the alternating first and second strands.

19D. The attachment system of any of Embodiments 12D to 18D, where there is a ribbon region adjacent and connected to one side of the netting.

20D. The attachment system of Embodiment 19D, wherein the netting and ribbon region are integral.

21D. The attachment system of either Embodiment 19D or 20D, wherein the ribbon region is inelastic.

22D. The article of any of Embodiments 19D to 21D, wherein the ribbon region has a major surface with the engagement posts thereon.

23D. An absorbent article comprising the attachment system of any of Embodiments 1D to 22D.

1E. An attachment system comprising an array of engagement posts (e.g., hooks) engaged with a netting, the netting comprising an array of polymeric strands periodically joined together at bond regions throughout the array, wherein the netting has a thickness up to 750 micrometers.

2E. The attachment system of Embodiment 1E, wherein the engagement posts are attached to a backing.

3E. The attachment system of Embodiment 2E, wherein the backing is one of a film, net, or non-woven.

4E. The attachment system of Embodiment 1E to 3E having a basis weight in a range from 0.5 g/m² to 40 g/m² (in some embodiments, 1 g/m² to 20 g/m²).

5E. The attachment system of any of Embodiments 1E to 4E having a strand pitch in a range from 0.5 mm to 20 mm (in some embodiments, in a range from 0.5 mm to 10 mm)

6E. The attachment system of any of Embodiments 1E to 5E that is elastic.

7E. The attachment system of any of Embodiments 1E to 6E, wherein the netting has a machine direction and a cross-machine direction, wherein the netting is elastic in machine direction, and inelastic in the cross-machine direction.

8E. The attachment system of any of Embodiments 1E to 6E, wherein the netting has a machine direction and a cross-machine direction, wherein the netting is inelastic in machine direction, and elastic in the cross-machine direction.

9E. The attachment system of any of Embodiments 1E to 8E, wherein at least some of the polymeric strands include at least one of a dye or pigment therein.

10E. The attachment system of any of Embodiments 1E to 9E, wherein the array polymeric strands exhibits at least one of diamond-shaped or hexagonal-shaped openings.

11E. The attachment system of any of Embodiments 1E to 10E, wherein at least some of the polymeric strands comprise polymer that is a thermoplastic (e.g., adhesives, nylons, polyesters, polyolefins, polyurethanes, elastomers (e.g., styrenic block copolymers), and blends thereof).

12E. The netting of any of Embodiments 1E to 11E, wherein the plurality of strands include alternating first and second polymeric strands, wherein the second polymeric strands comprise a second polymer.

13E. The attachment system of Embodiment 12E, wherein the first polymeric strands comprise the first polymer, and wherein the second polymeric strands comprise a second polymer that is a thermoplastic (e.g., adhesives, nylons, polyesters, polyolefins, polyurethanes, elastomers (e.g., styrenic block copolymers), and blends thereof).

14E. The attachment system of either Embodiments 12E or 13E, wherein the first strands have an average width in a range from 10 micrometers to 500 micrometers (in a range from 10 micrometers to 400 micrometers, or even 10 micrometers to 250 micrometers).

15E. The attachment system of any of Embodiments 12E to 14E, wherein the second strands have an average width in a range from 10 micrometers to 500 micrometers (in a range from 10 micrometers to 400 micrometers, or even 10 micrometers to 250 micrometers.

16E. The attachment system of any of Embodiments 1E to 15E, wherein the bond regions have an average largest dimension perpendicular to the strand thickness, wherein the polymeric strands have an average width, and wherein the average largest dimension of the bond regions is at least 2 (in some embodiments, at least 2.5, 3, 3.5, or even at least 4) times greater than the average width of the polymeric strands.

17E. The attachment system of any of Embodiments 1E to 16E, where there is a ribbon region adjacent and connected to one side of the netting.

18E. The attachment system of Embodiment 17E, wherein the netting and ribbon region are integral.

19E. The attachment system of either Embodiment 17E or 18E, wherein the ribbon region is inelastic.

20E. The attachment system of any of Embodiments 17E to 19E, wherein the ribbon region has a major surface with the engagement posts thereon.

21E. An absorbent article comprising the attachment system of any of Embodiments 1E to 20E.

1F. An array of alternating first and second polymeric strands, wherein the first and second strands periodically join together at bond regions throughout the array, wherein the first strands have an average first yield strength, and wherein the second strands have an average second yield strength that is different (e.g., at least 10 percent different) than the first yield strength.

2F. The array of alternating first and second polymeric strands of Embodiment 1F, wherein the array has a thickness up to 2 mm (in some embodiments, up to 1.5 mm, 1 mm, 750 micrometers, 500 micrometers, 250 micrometers, 100 micrometers, 75 micrometers, 50 micrometers, or even up to 25 micrometers; in a range from 10 micrometers to 2 mm, 10 micrometers to 1.5 mm, 10 micrometers to 1 mm, 10 micrometers to 750 micrometers, 10 micrometers to 500 micrometers, 10 micrometers to 250 micrometers, 10 micrometers to 100 micrometers, 10 micrometers to 75 micrometers, 10 micrometers to 50 micrometers, or even 10 micrometers to 25 micrometers).

3F. The array of either Embodiment 1F or 2F having a strand pitch in a range from 0.5 mm to 20 mm (in some embodiments, in a range from 0.5 mm to 10 mm)

4F. The array of any of Embodiments 1F to 3F, wherein at least one of the first or second polymeric materials each include at least one of a dye or pigment therein.

5F. The array of any of Embodiments 1F to 4F having at least one of diamond-shaped or hexagonal-shaped openings.

6F. The array of any of Embodiments 1F to 5F, wherein the first polymer is a thermoplastic (e.g., adhesives, nylons, polyesters, polyolefins, polyurethanes, elastomers (e.g., styrenic block copolymers), and blends thereof).

7F. The array of any of Embodiments 1F to 6F, wherein the first polymer is an adhesive material.

8F. The array of any of Embodiments 1F to 7F, wherein the second polymer is a thermoplastic (e.g., adhesives, nylons, polyesters, polyolefins, polyurethanes, elastomers (e.g., styrenic block copolymers), and blends thereof).

9F. The array of any of Embodiments 1F to 8F, wherein the first strands have an average width in a range from 10 micrometers to 500 micrometers (in a range from 10 micrometers to 400 micrometers, or even 10 micrometers to 250 micrometers).

10F. The array of any of Embodiments 1F to 9F, wherein the second strands have an average width in a range from 10 micrometers to 500 micrometers (in a range from 10 micrometers to 400 micrometers, or even 10 micrometers to 250 micrometers).

11F. The array of any of Embodiments 1F to 10F, wherein the first strands, second strands, and bond regions each have thicknesses that are substantially the same.

12F. The array of any of Embodiments 1F to 11F, wherein the bond regions have an average largest dimension perpendicular to the strand thickness, and wherein the average largest dimension of the bond regions is at least 2 (in some embodiments, at least 2.5, 3, 3.5, or even at least 4) times greater than the average width of at least one of the first strands or the second strands.

13F. An article comprising a backing having the array of any of Embodiments 1F to 12F on a major surface thereof.

14F. The article of Embodiment 13F, wherein the backing is one of a film, net, or non-woven.

15F. An article comprising two arrays of any of Embodiments 1F to 14F with a ribbon region disposed there between.

16F. The article of Embodiment 15F, wherein the array and ribbon region are integral.

17F. The article of either Embodiment 14F or 15F, wherein the ribbon region has a major surface with the engagement posts thereon.

18F. An article comprising the array of any of Embodiments 1F to 17F disposed between two ribbon regions.

19F. The article of Embodiment 18F, wherein the array is integral with each of the ribbon regions.

20F. The article of either Embodiment 16F or 17F, wherein the film has a major surface with the engagement posts thereon.

21F. A wound dressing comprising the array of alternating first and second polymeric strands of any of Embodiments 1F to 20F.

22F. A method of making the array of alternating first and second polymeric strands of any of Embodiments 1F to 21F, the method comprising:

providing an extrusion die comprising a plurality of shims positioned adjacent to one another, the shims together defining a first cavity and a second cavity, the extrusion die having a plurality of first dispensing orifices in fluid communication with the first cavity and having a plurality of second dispensing orifices connected to the second cavity, such that the first and second dispensing orifices are alternated; and

dispensing first polymeric strands from the first dispensing orifices at a first strand speed while simultaneously dispensing second polymeric strands from the second dispensing orifices at a second strand speed, wherein the first strand speed is at least 2 (in some embodiments, in a range from 2 to 6 or even 2 to 4) times the second strand speed to provide the array of alternating first and second polymeric strands.

23F. The method according to Embodiment 22F, wherein the plurality of shims comprises a plurality of a repeating sequence of shims that includes a shim that provides a passageway between the first cavity and at least one of the first dispensing orifices and a shim that provides a passageway between the second cavity and the at least one of the second dispensing orifices.

24F. The method according to either of Embodiments 20F or 21F, wherein the repeating sequence further comprises at least one spacer shim.

25F. The method according to any of Embodiments 20F to 24F comprising at least 1000 of the shims

26F. The method according to any of Embodiments 20F to 25F, wherein the first dispensing orifices and the second dispensing orifices are collinear.

27F. The method according to any of Embodiments 20F to 26F, wherein the first dispensing orifices are collinear, and the second dispensing orifices are collinear but offset from the first dispensing orifices.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

### Test Methods

### Shear-Engaged Peel Test

A 25.4 mm wide by 12.7 mm length hook sample (obtained under the trade designation “KN2854” from 3M Company, St. Paul, Minn.) was affixed to a 25.4 mm strip of printer paper with adhesive tape (obtained under the trade designation “TRM-300 Double Coated Tape” from 3M Company). The 12.7 mm edge of the hook was in the machine direction. The loop was cut into 25.4 mm wide strips along the machine direction of the sample. The hook and loop were mated aligning the machine directions and rolled down with a 2.05 kg rubber coated roller, one cycle forward and back. The construction was loaded in shear with a 500 gram dead weight for 10 seconds.

The peel was measured in a tensile tester, (obtained under the trade designation “INSTRON 5500R Series” from Instron Engineering Corp., Canton, Mass.). The instrument was calibrated to an accuracy of 1 percent of the full scale and the scale range used for the test was within 10-90 percent of full range. The initial jaw separation was 76.2 mm. The sample was peeled to failure at a constant rate of 300 mm/min. A minimum of 5 tests are performed and averaged for each hook and loop combination.

The maximum peel force and average peel force, both in N/25.4 mm, are reported.

### Dynamic Shear Test

The Dynamic Shear Test was used to measure the amount of force required to shear the sample of mechanical fastener hook material from a sample of loop fastener material. A 2.5 cm by 7.5 cm loop sample was cut with the short dimension being the machine direction of the hook. This loop sample was then reinforced with filament tape (obtained under the trade designation “#898 filament tape” from 3M Company). A 1.25 cm by 2.5 cm hook sample (“KN2854”) was also prepared. The long dimension is the machine direction of the hook. This sample was laminated to the end of a tab of filament tape 2.5 cm wide by 7.5 cm long. The filament tape was doubled over on itself on the end without hook to cover the adhesive. The hook was then placed centrally on the loop with long tab directions parallel to each other such that the loop tab extended past on the first end and the hook tab extended past on the second end. The hook was rolled down by hand with a 5 kg steel roll, 5 replicates up and back. The assembled tabs were placed into the jaws of a tensile tester (obtained under the trade designation “INSTRON 5500R Series” from Instron Engineering Corp.). The hook tab placed in the top jaw, the loop tab placed in the bottom jaw. The sample was sheared to failure in a 180 degree angle at a crosshead speed of 30.5 cm per minute. The maximum load was recorded in grams. The force required to shear the mechanical fastener strip from the loop material was reported in grams/2.54 cm-width. A minimum of 5 tests were run and averaged for each hook and loop combination.

### Example 1

A co-extrusion die as generally depicted in FIG. 1 was prepared. The thickness of each shim was 2 mil (0.051 mm) Five identical shims were stacked together to create an orifice width of 10 mils (0.254 mm) to the first cavity. Five identical shims were stacked together to create an orifice width of 10 mils (0.254 mm) to the second cavity. Three identical shims were stacked together to create an effective shim width of 6 mils (0.152 mm) for the spacer between orifices. The shims were formed from stainless steel, with perforations cut by a wire electron discharge machining. The height of the first extrusion orifice was cut to 10 mils (0.254 mm) The height of the second set of extrusion orifices was cut to 10 mils (0.254 mm) The extrusion orifices were aligned in a collinear, alternating arrangement with a dispensing surface generally as shown in FIG. 11. The total width of the shim setup was 5 cm.

The inlet fittings on the two end blocks were each connected to a conventional single-screw extruder. A chill roll was positioned adjacent to the distal opening of the co-extrusion die to receive the extruded material. The extruder feeding the first cavity was loaded with thirty-five melt flow index polypropylene pellets (obtained under the trade designation “EXXONMOBIL 3155 PP” from ExxonMobil, Irving, Tex.).

The extruder feeding the second cavity was loaded with twelve melt flow index polypropylene pellets (obtained under the trade designation “EXXONMOBIL 1024 PP” from ExxonMobil). Other process conditions are listed below:

| Orifice width: | 0.254 | mm |
|---|---|---|
| Orifice height: | 0.254 | mm |
| Ratio of orifice height to width | 1:1 | |
| Ratio of first and second orifice area | 1:1 | |
| Land spacing between orifices | 0.152 | mm |
| Flow rate of first polymer | 1.7 | kg/hr. |
| Flow rate of second polymer | 0.47 | kg/hr. |
| Flow rate ratio first to second polymer | 3.6:1 | |
| Extrusion temperature | 205° | C. |
| Quench roll temperature | 50° | C. |

Quench takeaway speed 9 m/min.

Using an optical microscope, the netting dimensions were measured and are shown below.

| | | |
|---|---|---|
| Netting thickness | 0.275 | mm |
| Netting basis weight | 155 | g/m² |
| Bond length in the machine direction | 1.9 | mm |
| Net bonding distance in the machine direction (pitch) | 2.08 | mm |
| First polymer strand width | 0.260 | mm |
| Second polymer strand width | 0.120 | mm |

The resulting netting had strand cross-sections of equal width and thickness with a cross sectional area ratio of 3.6:1. A digital optical image at 10× of the netting is shown in FIG. 13, with first strands 1370a and second strands 1370b.

### Example 2

Example 2 was made with the same die setup and materials as Example 1 except with the following conditions listed below:

| Orifice width: | 0.254 | mm |
|---|---|---|
| Orifice height: | 0.254 | mm |
| Ratio of orifice height to width | 1:1 | |
| Ratio of first and second orifice area | 1:1 | |
| Land spacing between orifices | 0.152 | mm |
| Flow rate of first polymer | 1.7 | kg/hr. |
| Flow rate of second polymer | 0.65 | kg/hr. |
| Flow rate ratio first to second polymer | 2.5:1 | |
| Extrusion temperature | 205° | C. |
| Quench roll temperature | 50° | C. |
| Quench takeaway speed | 9 | m/min. |

Using an optical microscope, the netting dimensions were measured and are shown below.

| | | |
|---|---|---|
| Netting thickness | 0.35 | mm |
| Netting basis weight | 170 | g/m² |
| Bond length in the machine direction | 2.2 | mm |
| Net bonding distance in the machine direction (pitch) | 3.6 | mm |
| First polymer strand width | 0.235 | mm |
| Second polymer strand width | 0.15 | mm |

The resulting netting had first to second strand cross-sections with a cross sectional area ratio of 2.5:1. A digital optical image at 10× of the netting is shown in FIG. 14, with first strands 1470a and second strands 1470b.

### Example 3

A co-extrusion die as generally depicted in FIG. 1 was prepared. The thickness of each shim was 4 mils (0.102 mm) Four identical shims were stacked together to create an orifice width of 16 mils (0.406 mm) to the first cavity. Four identical shims were stacked together to create an orifice width of 16 mils (0.406 mm) to the second cavity. Two spacer shims provided the spacer between orifices. The shims were formed from stainless steel, with perforations cut by a wire electron discharge machining The height of the first extrusion orifice was cut to 30 mils (0.762 mm) The height of the second set of extrusion orifices was cut to 10 mils (0.254 mm) The extrusion orifices were aligned in a collinear arrangement as shown in FIG. 15. The total width of the shim setup was 7.5 cm.

The inlet fittings on the two end blocks were each connected to a conventional single-screw extruder. A chill roll was positioned adjacent to the distal opening of the co-extrusion die to receive the extruded material. The extruder feeding the first cavity was loaded with thirty-five melt flow index polypropylene pellets (“EXXONMOBIL 3155 PP”).

The extruder feeding the second cavity was loaded with twelve melt flow index polypropylene pellets (“EXXONMOBIL 3155 PP”). Other process conditions are listed below:

| Orifice width for the first cavity: | 0.406 | mm |
|---|---|---|
| Orifice height for the first cavity: | 0.762 | mm |
| Orifice width of the second cavity: | 0.406 | mm |
| Orifice height of the second cavity: | 0.254 | mm |
| Ratio of orifice height to width for the oscillating strand | 0.625:1 | |
| Ratio of first and second orifice area | 3:1 | |
| Land spacing between orifices | 0.203 | mm |
| Flow rate of first polymer | 1.36 | kg/hr. |
| Flow rate of second polymer | 1.32 | kg/hr. |
| Flow rate ratio first to second polymer | 1:1 | |
| Extrusion temperature | 227° | C. |
| Quench roll temperature | 55° | C. |
| Quench takeaway speed | 6 | m/min. |

Using an optical microscope, the netting dimensions were measured and are shown below.

| | | |
|---|---|---|
| Netting thickness | 0.28 | mm |
| Netting basis weight | 96 | g/m² |
| Bond length in the machine direction | 2.8 | mm |
| Net bonding distance in the machine direction (pitch) | 7.7 | mm |
| First polymer strand width | 0.30 | mm |
| Second polymer strand width | 0.26 | mm |

The resulting netting had first to second strand cross-sections with a cross sectional area ratio of 1:1. A digital optical image at 10× of the netting is shown in FIG. 16, with first strands 1670a and second strands 1670b.

### Example 4

A co-extrusion die as generally depicted in FIG. 1 was prepared. The thickness of each shim was 2 mil (0.051 mm) Three identical shims were stacked together to create an orifice width of 6 mils (0.152 mm) to the first cavity. Three identical shims were stacked together to create an orifice width of 6 mils (0.152 mm) to the second cavity. Two identical shims were stacked together to create an effective shim width of 4 mils (0.102 mm) for the spacer between orifices. The shims were formed from stainless steel, with perforations cut by a wire electron discharge machining. The height of the first extrusion orifice was cut to 10 mils (0.254 mm) The height of the second set of extrusion orifices was cut to 10 mils (0.254 mm) The extrusion orifices were aligned in a collinear, alternating arrangement as shown in FIG. 12. The total width of the shim setup was 5 cm.

The inlet fittings on the two end blocks were each connected to a conventional single-screw extruder. A chill roll was positioned adjacent to the distal opening of the co-extrusion die to receive the extruded material. The extruder feeding the first cavity was loaded with thirty-five melt flow index polypropylene pellets (“EXXONMOBIL 3155 PP”).

The extruder feeding the second cavity was loaded with twelve melt flow index polypropylene pellets (“EXXONMOBIL 1024 PP”). Other process conditions are listed below:

| Orifice width: | 0.152 | mm |
|---|---|---|
| Orifice height: | 0.254 | mm |
| Ratio of orifice height to width | 1.67:1 | |
| Ratio of first and second orifice area | 1:1 | |
| Land spacing between orifices | 0.102 | mm |
| Flow rate of first polymer | 0.5 | kg/hr. |
| Flow rate of second polymer | 0.18 | kg/hr. |
| Flow rate ratio first to second polymer | 2.8:1 | |
| Extrusion temperature | 205° | C. |
| Quench roll temperature | 50° | C. |
| Quench takeaway speed | 9 | m/min. |

Using an optical microscope, the netting dimensions were measured and are shown below.

| | | |
|---|---|---|
| Netting thickness | 0.16 | mm |
| Netting basis weight | 50 | g/m² |
| Bond length in the machine direction | 1.6 | mm |
| Net bonding distance in the machine direction (pitch) | 4.6 | mm |
| First polymer strand width | 0.110 | mm |
| Second polymer strand width | 0.05 | mm |

The resulting netting had first to second strand cross-sections with a cross sectional area ratio of 2.8:1. A digital optical image at 10× of the netting is shown in FIG. 17, with first strands 1770a and second strands 1770b.

The die swell of the polymer strands was also measured as the polymer exited the die.

| First polymer die swell width | 0.25 mm |
|---|---|
| Second polymer die swell width | 0.125 |

### Example 5

A co-extrusion die as generally depicted in FIG. 1 was prepared. The thickness of each shim was 2 mil (0.051 mm) Two identical shims were stacked together to create an orifice width of 4 mils (0.102 mm) to the first cavity. Two identical shims were stacked together to create an orifice width of 4 mils (0.102 mm) to the second cavity. One shim formed the spacer between orifices. The shims were formed from stainless steel, with perforations cut by a wire electron discharge machining. The height of the first extrusion orifice was cut to 10 mils (0.254 mm) The height of the second set of extrusion orifices was cut to 10 mils (0.254 mm) The extrusion orifices with connection to the first cavity were aligned in a collinear arrangement. The extrusion orifices with connection to the second cavity were aligned in a collinear arrangement. The alignment of the first and second set of orifices was offset by 100%, as shown in FIG. 5. The total width of the shim setup was 5 cm.

The inlet fittings on the two end blocks were each connected to a conventional single-screw extruder. A chill roll was positioned adjacent to the distal opening of the co-extrusion die to receive the extruded material. The extruder feeding the first cavity was loaded with thirty-five melt flow index polypropylene pellets (“EXXONMOBIL 3155 PP”).

The extruder feeding the second cavity was loaded with twelve melt flow index polypropylene pellets (“EXXONMOBIL 1024 PP”). Other process conditions are listed below:

| Orifice width: | 0.102 | mm |
|---|---|---|
| Orifice height: | 0.254 | mm |
| Ratio of orifice height to width | 2.5:1 | |
| Ratio of first and second orifice area | 1:1 | |
| Land spacing between orifices | 0.05 | mm |
| Flow rate of first polymer | 1.12 | kg/hr. |
| Flow rate of second polymer | 0.25 | kg/hr. |
| Flow rate ratio first to second polymer | 4.5:1 | |
| Extrusion temperature | 205° | C. |
| Quench roll temperature | 50° | C. |
| Quench takeaway speed | 4.5 | m/min. |

Using an optical microscope, the netting dimensions were measured and are shown below.

| | | |
|---|---|---|
| Netting thickness | 0.35 | mm |
| Netting basis weight | 130 | g/m² |
| Bond length in the machine direction | 0.4 | mm |
| Net bonding distance in the machine direction (pitch) | 0.83 | mm |
| First polymer strand width | 0.160 | mm |
| Second polymer strand width | 0.075 | mm |

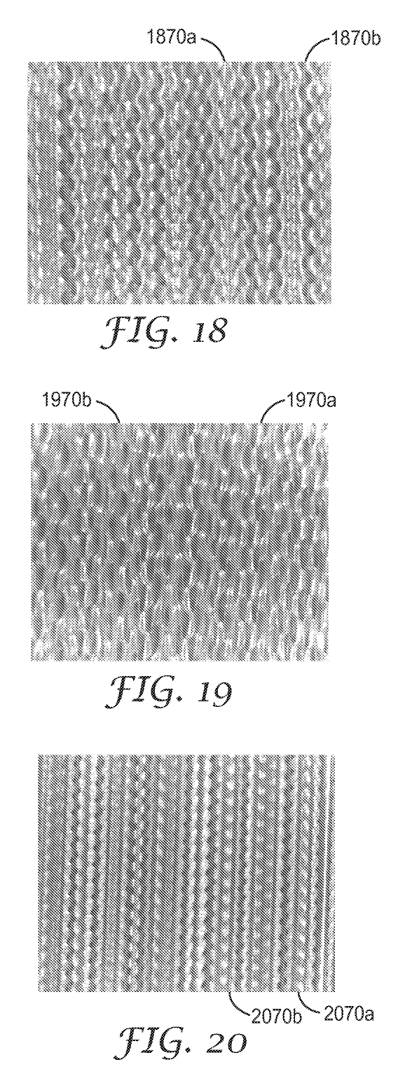

The resulting netting had first to second strand cross-sections with a cross sectional area ratio of 4.5:1. A digital optical image at 10× of the netting is shown in FIG. 18, with first strands 1870a and second strands 1870b.

### Example 6

Example 6 was made with the same die setup and materials as Example 5 except with the following conditions listed below:

| Orifice width: | 0.102 | mm |
|---|---|---|
| Orifice height: | 0.254 | mm |
| Ratio of orifice height to width | 2.5:1 | |
| Ratio of first and second orifice area | 1:1 | |
| Land spacing between orifices | 0.05 | mm |
| Flow rate of first polymer | 1.12 | kg/hr. |
| Flow rate of second polymer | 0.25 | kg/hr. |
| Flow rate ratio first to second polymer | 4.5:1 | |
| Extrusion temperature | 205° | C. |
| Quench roll temperature | 50° | C. |
| Quench takeaway speed | 9 | m/min. |

Using an optical microscope, the netting dimensions were measured and are shown below.

| | | |
|---|---|---|
| Netting thickness | 0.225 | mm |
| Netting basis weight | 65 | g/m² |
| Bond length in the machine direction | 0.6 | mm |
| Net bonding distance in the machine direction (pitch) | 1.5 | mm |
| First polymer strand width | 0.110 | mm |
| Second polymer strand width | 0.070 | mm |

The resulting netting had first to second strand cross-sections with a cross sectional area ratio of 4.5:1. A digital optical image at 10× of the netting is shown in FIG. 19, with First strands 1970a and second strands 1970b.

### Example 7

Example 7 was made with the same die setup and materials as Example 5 except with the following conditions listed below:

| Orifice width: | 0.102 | mm |
|---|---|---|
| Orifice height: | 0.254 | mm |
| Ratio of orifice height to width | 2.5:1 | |
| Ratio of first and second orifice area | 1:1 | |
| Land spacing between orifices | 0.05 | mm |
| Flow rate of first polymer | 2.1 | kg/hr. |
| Flow rate of second polymer | 0.5 | kg/hr. |
| Flow rate ratio first to second polymer | 4.1:1 | |
| Extrusion temperature | 205° | C. |
| Quench roll temperature | 50° | C. |
| Quench takeaway speed | 4.5 | m/min. |

Using an optical microscope, the netting dimensions were measured and are shown below.

| | | |
|---|---|---|
| Netting thickness | 0.50 | mm |
| Netting basis weight | 245 | g/m² |
| Bond length in the machine direction | 0.26 | mm |
| Net bonding distance in the machine direction (pitch) | 0.55 | mm |
| First polymer strand width | 0.150 | mm |
| Second polymer strand width | 0.080 | mm |

The resulting netting had first to second strand cross-sections with a cross sectional area ratio of 4.1:1. A digital optical image at 10× of the netting is shown in FIG. 20, with first strands 2070a and second strands 2070b.

### Example 8

Example 8 was made with the same die setup and materials as Example 5 except with the following conditions listed below:

| Orifice width: | 0.102 | mm |
|---|---|---|
| Orifice height: | 0.254 | mm |
| Ratio of orifice height to width | 2.5:1 | |
| Ratio of first and second orifice area | 1:1 | |
| Land spacing between orifices | 0.05 | mm |
| Flow rate of first polymer | 2.1 | kg/hr. |
| Flow rate of second polymer | 0.5 | kg/hr. |
| Flow rate ratio first to second polymer | 4.1:1 | |
| Extrusion temperature | 205° | C. |
| Quench roll temperature | 50° | C. |
| Quench takeaway speed | 9.0 | m/min. |

Using an optical microscope, the netting dimensions were measured and are shown below.

| | | |
|---|---|---|
| Netting thickness | 0.325 | mm |
| Netting basis weight | 125 | g/m² |
| Bond length in the machine direction | 0.35 | mm |
| Net bonding distance in the machine direction (pitch) | 1.0 | mm |
| First polymer strand width | 0.150 | mm |
| Second polymer strand width | 0.070 | mm |

The resulting netting had first to second strand cross-sections with a cross sectional area ratio of 4.1:1. A digital optical image at 10× of the netting is shown in FIG. 21 with first strands 2170a and second strands 2170b.

Examples 4-7 demonstrate that the strand net bonding rate increases as the strand polymer throughput rate is increased. The net bonding pitch increases as the drawing rate from the die increases for a given polymer throughput rate.

### Example 9

Example 9 was made with the same die setup and materials as Example 5 except with the following conditions listed below:

| Orifice width: | 0.102 | mm |
|---|---|---|
| Orifice height: | 0.254 | mm |
| Ratio of orifice height to width | 2.5:1 | |
| Ratio of first and second orifice area | 1:1 | |
| Land spacing between orifices | 0.05 | mm |
| Flow rate of first polymer | 2.0 | kg/hr. |
| Flow rate of second polymer | 1.0 | kg/hr. |
| Flow rate ratio first to second polymer | 2.0:1 | |
| Extrusion temperature | 205° | C. |
| Quench roll temperature | 50° | C. |
| Quench takeaway speed | 9 | m/min. |

Using an optical microscope, the netting dimensions were measured and are shown below.

| | | |
|---|---|---|
| Netting thickness | 0.325 | mm |
| Netting basis weight | 140 | g/m² |
| Bond length in the machine direction | 0.35 | mm |
| Net bonding distance in the machine direction (pitch) | 0.9 | mm |
| First polymer strand width | 0.170 | mm |
| Second polymer strand width | 0.110 | mm |

The resulting netting had first to second strand cross-sections with a cross sectional area ratio of 2.0:1. A digital optical image at 10× of the netting is shown in FIG. 22, with first strands 2270a and second strands 2270b.

### Example 10

Example 10 was made with the same die setup as Example 5.

The inlet fittings on the two end blocks were each connected to a conventional single-screw extruder. A chill roll was positioned adjacent to the distal opening of the co-extrusion die to receive the extruded material. The extruder feeding the first cavity was loaded with twenty-two melt flow index copolymer polypropylene pellets (“VISTAMAX 1120”).

The extruder feeding the second cavity was loaded with twenty-two melt flow index copolymer polypropylene pellets (“VISTAMAX 1120”). Other process conditions are listed below:

| Orifice width: | 0.102 | mm |
|---|---|---|
| Orifice height: | 0.254 | mm |
| Ratio of orifice height to width | 2.5:1 | |
| Ratio of first and second orifice area | 1:1 | |
| Land spacing between orifices | 0.05 | mm |
| Flow rate of first polymer | 2.0 | kg/hr. |
| Flow rate of second polymer | 1.18 | kg/hr. |
| Flow rate ratio first to second polymer | 1.7:1 | |
| Extrusion temperature | 205° | C. |
| Quench roll temperature | 50° | C. |
| Quench takeaway speed | 6.1 | m/min. |

Using an optical microscope, the netting dimensions were measured and are shown below.

| | | |
|---|---|---|
| Netting thickness | 0.425 | mm |
| Netting basis weight | 225 | g/m² |
| Bond length in the machine direction | 0.35 | mm |
| Net bonding distance in the machine direction (pitch) | 0.82 | mm |
| First polymer strand width | 0.085 | mm |
| Second polymer strand width | 0.050 | mm |

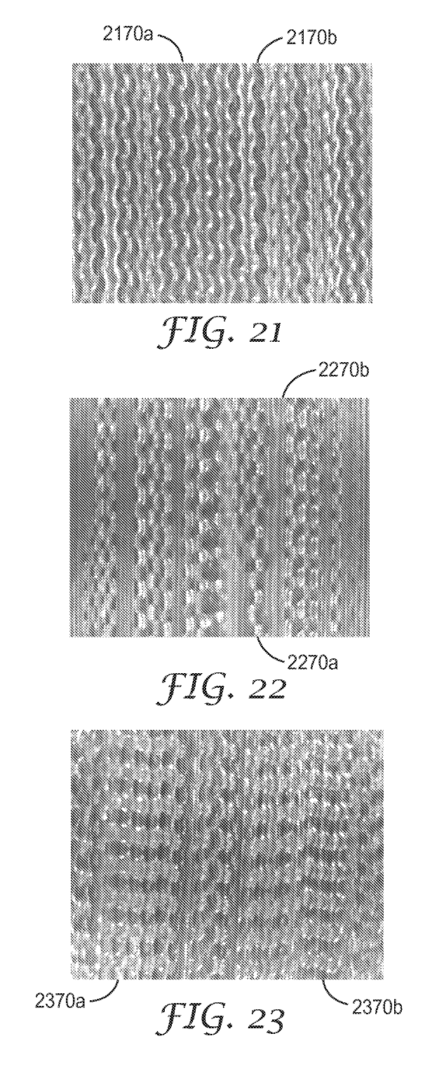

The resulting netting had first to second strand cross-sections with a cross sectional area ratio of 1.7:1. A digital optical image at 10× of the netting is shown in FIG. 23, with first strands 2370a and second strands 2370b.

### Example 11

A co-extrusion die as generally depicted in FIG. 1 was prepared. The thickness of each shim was 2 mil (0.051 mm) Two identical shims were stacked together to create an orifice width of 4 mils (0.102 mm) to the first cavity. Two identical shims were stacked together to create an orifice width of 4 mils (0.102 mm) to the second cavity. Two identical shims were stacked together to create an effective shim width of 4 mils (0.102 mm) for the spacer between orifices. The shims were formed from stainless steel, with perforations cut by a wire electron discharge machining. The height of the first extrusion orifice was cut to 10 mils (0.254 mm) The height of the second set of extrusion orifices was cut to 10 mils (0.254 mm) The extrusion orifices were aligned in a collinear, alternating arrangement as shown in FIG. 24. The total width of the shim setup was 5 cm.

The inlet fittings on the two end blocks were each connected to a conventional single-screw extruder. A chill roll was positioned adjacent to the distal opening of the co-extrusion die to receive the extruded material. The extruder feeding the first cavity was loaded with thirty-five melt flow index polypropylene pellets (“EXXONMOBIL 3155 PP”).

The extruder feeding the second cavity was loaded with twelve melt flow index polypropylene pellets (“EXXONMOBIL 1024 PP”). Other process conditions are listed below:

| Orifice width: | 0.102 | mm |
|---|---|---|
| Orifice height: | 0.254 | mm |
| Ratio of orifice height to width | 2.5:1 | |
| Ratio of first and second orifice area | 1:1 | |
| Land spacing between orifices | 0.102 | mm |
| Flow rate of first polymer | 1.2 | kg/hr. |
| Flow rate of second polymer | 0.21 | kg/hr. |
| Flow rate ratio first to second polymer | 5.7:1 | |
| Extrusion temperature | 205° | C. |
| Quench roll temperature | 50° | C. |
| Quench takeaway speed | 9 | m/min. |

Using an optical microscope, the netting dimensions were measured and are shown below.

| | | |
|---|---|---|
| Netting thickness | 0.175 | mm |
| Netting basis weight | 70 | g/m² |
| Bond length in the machine direction | 0.55 | mm |
| Net bonding distance in the machine direction (pitch) | 1.4 | mm |
| First polymer strand width | 0.125 | mm |
| Second polymer strand width | 0.065 | mm |

The resulting netting had first to second strand cross-sections with a cross sectional area ratio of 5.7:1. A digital optical image at 10× of the netting is shown in FIG. 25, with first strands 2570a and second strands 2570b.

### Example 12

Example 12 was made with the same die setup as Example 11.

The inlet fittings on the two end blocks were each connected to a conventional single-screw extruder. A chill roll was positioned adjacent to the distal opening of the co-extrusion die to receive the extruded material. The extruder feeding the first cavity was loaded with one hundred melt flow index polypropylene pellets (obtained under the trade designation “TOTAL 3860” from Total Petrochemicals, Houston, Tex.).

The extruder feeding the second cavity was loaded with twelve melt flow index polypropylene pellets (“EXXONMOBIL 1024 PP”). Other process conditions are listed below:

| Orifice width: | 0.102 | mm |
|---|---|---|
| Orifice height: | 0.254 | mm |
| Ratio of orifice height to width | 2.5:1 | |
| Ratio of first and second orifice area | 1:1 | |
| Land spacing between orifices | 0.102 | mm |
| Flow rate of first polymer | 1.0 | kg/hr. |
| Flow rate of second polymer | 0.3 | kg/hr. |
| Flow rate ratio first to second polymer | 3.0:1 | |
| Extrusion temperature | 205° | C. |
| Quench roll temperature | 50° | C. |
| Quench takeaway speed | 9 | m/min. |

Using an optical microscope, the netting dimensions were measured and are shown below.

| | | |
|---|---|---|
| Netting thickness | 0.150 | mm |
| Netting basis weight | 65 | g/m² |
| Bond length in the machine direction | 0.9 | mm |
| Net bonding distance in the machine direction (pitch) | 2.3 | mm |
| First polymer strand width | 0.140 | mm |
| Second polymer strand width | 0.07 | mm |

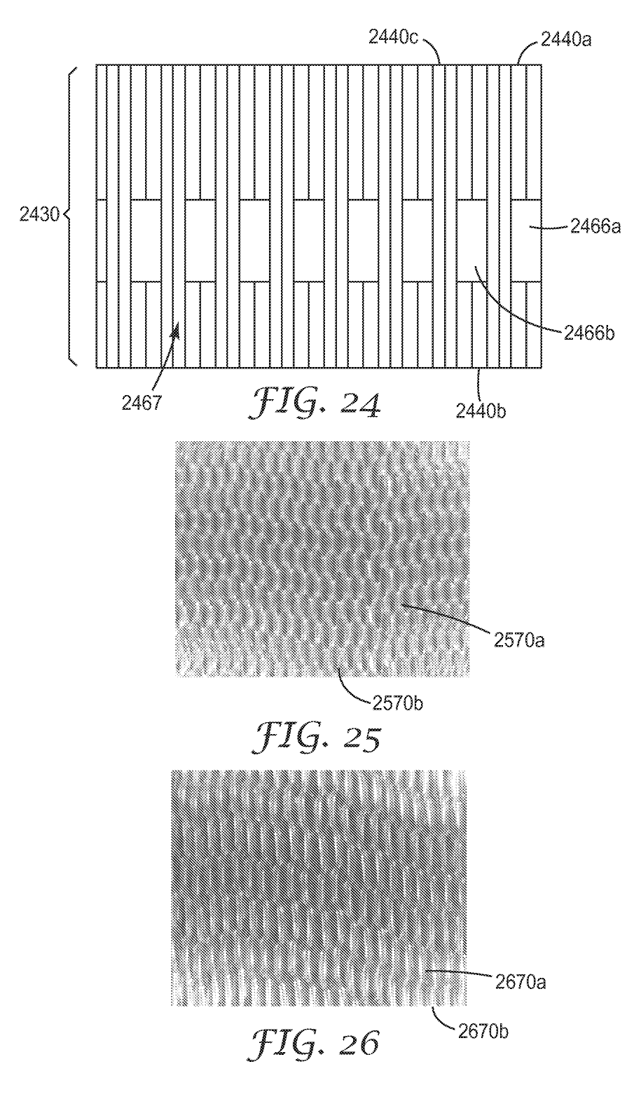

The resulting netting had first to second strand cross-sections with a cross sectional area ratio of 3:1. A digital optical image at 10× of the netting is shown in FIG. 26, with first strands 2670a and second strands 2670b.

### Example 13

A co-extrusion die as generally depicted in FIG. 1 was prepared. The thickness of each shim was 4 mils (0.102 mm) Eight identical shims were stacked together to create an orifice width of 32 mils (0.813 mm) to the first cavity. Four identical shims were stacked together to create an orifice width of 16 mils (0.406 mm) to the second cavity. Six identical shims were stacked together to create an effective shim width of 24 mils (0.610 mm) for the spacer between orifices. The shims were formed from stainless steel, with perforations cut by a wire electron discharge machining. The height of the first extrusion orifice was cut to 30 mils (0.762 mm) The height of the second set of extrusion orifices was cut to 30 mils (0.762 mm) The extrusion orifices were aligned in a collinear, alternating arrangement as shown in FIG. 27. The total width of the shim setup was 5 cm.

The inlet fittings on the two end blocks were each connected to a conventional single-screw extruder. A chill roll was positioned adjacent to the distal opening of the co-extrusion die to receive the extruded material. The extruder feeding the first cavity was loaded with thirty-five melt flow index polypropylene pellets (“EXXONMOBIL 3155 PP”).

The extruder feeding the second cavity was loaded with twelve melt flow index polypropylene pellets (“EXXONMOBIL 3155 PP”). Other process conditions are listed below:

| Orifice width for the first cavity: | 0.813 | mm |
|---|---|---|
| Orifice height for the first cavity: | 0.762 | mm |
| Orifice width of the second cavity: | 0.406 | mm |
| Orifice height of the second cavity: | 0.762 | mm |
| Ratio of orifice height to width for oscillating strand | 1.88:1 | |
| Ratio of first and second orifice area | 2:1 | |
| Land spacing between orifices | 0.610 | mm |
| Flow rate of first polymer | 1.5 | kg/hr. |
| Flow rate of second polymer | 1.73 | kg/hr. |
| Flow rate ratio first to second polymer | 0.9:1 | |
| Extrusion temperature | 205° | C. |
| Quench roll temperature | 18° | C. |
| Quench takeaway speed | 9 | m/min. |

Using an optical microscope, the netting dimensions were measured and are shown below.

| | | |
|---|---|---|
| Netting thickness | 0.56 | mm |
| Netting basis weight | 230 | g/m² |
| Bond length in the machine direction | 2.1 | mm |
| Net bonding distance in the machine direction (pitch) | 16 | mm |
| First polymer strand width | 0.30 | mm |
| Second polymer strand width | 0.40 | mm |

The resulting netting had first to second strand cross-sections with a cross sectional area ratio of 0.9:1. A digital optical image at 10× of the netting is shown in FIG. 28, with first strands 2870a and second strands 2870b.

### Example 14

A co-extrusion die as generally depicted in FIG. 1 was prepared. The thickness of each shim was 4 mils (0.102 mm) Four identical shims were stacked together to create an orifice width of 16 mils (0.406 mm) to the first cavity. Two identical shims were stacked together to create an orifice width of 8 mils (0.203 mm) to the second cavity. Three identical shims were stacked together to create an effective shim width of 12 mils (0.305 mm) for the spacer between orifices. The shims were formed from stainless steel, with perforations cut by a wire electron discharge machining. The height of the first extrusion orifice was cut to 30 mils (0.762 mm) The height of the second set of extrusion orifices was cut to 30 mils (0.762 mm) The extrusion orifices were aligned in a collinear, alternating arrangement as shown in FIG. 29. The total width of the shim setup was 15 cm.

The inlet fittings on the two end blocks were each connected to a conventional single-screw extruder. A chill roll was positioned adjacent to the distal opening of the co-extrusion die to receive the extruded material. The extruder feeding the first cavity was loaded with thermoplastic polyurethane pellets (obtained under the trade designation “IROGRAN 440” from Huntsman, Auburn Hills, Mich.).

The extruder feeding the second cavity was loaded with thermoplastic polyurethane pellets (“IROGRAN 440”). Other process conditions are listed below:

| Orifice width for the first cavity: | 0.406 | mm |
|---|---|---|
| Orifice height for the first cavity: | 0.762 | mm |
| Orifice width of the second cavity: | 0.203 | mm |
| Orifice height of the second cavity: | 0.762 | mm |
| Ratio of orifice height to width for oscillating strand | 3.75:1 | |
| Ratio of first and second orifice area | 2:1 | |
| Land spacing between orifices | 0.305 | mm |
| Flow rate of first polymer | 2.1 | kg/hr. |
| Flow rate of second polymer | 3.2 | kg/hr. |
| Flow rate ratio first to second polymer | 0.64:1 | |
| Extrusion temperature | 218° | C. |
| Quench roll temperature | 13° | C. |
| Quench takeaway speed | 4.4 | m/min. |

Using an optical microscope, the netting dimensions were measured and are shown below.

| | | |
|---|---|---|
| Netting thickness | 0.375 | mm |
| Netting basis weight | 325 | g/m² |
| Bond length in the machine direction | 1.5 | mm |
| Net bonding distance in the machine direction (pitch) | 5.4 | mm |
| First polymer strand width | 0.20 | mm |
| Second polymer strand width | 0.25 | mm |

The resulting netting had first to second strand cross-sections with a cross sectional area ratio of 0.64:1. A digital optical image at 10× of the netting is shown in FIG. 30, with first strands 3070a and second strands 3070b.

### Example 15

Example 15 was made with the same die as Example 14. The inlet fittings on the two end blocks were each connected to a conventional single-screw extruder. A chill roll was positioned adjacent to the distal opening of the co-extrusion die to receive the extruded material. The extruder feeding the first cavity was loaded with styrene ethylene/butylene block copolymer pellets (obtained under the trade designation “KRATON 1657” from Kraton Polymers, Houston, Tex.).

The extruder feeding the second cavity was loaded with styrene ethylene/butylene block copolymer pellets (“KRATON 1657”). Other process conditions are listed below:

| Orifice width for the first cavity: | 0.406 | mm |
|---|---|---|
| Orifice height for the first cavity: | 0.762 | mm |
| Orifice width of the second cavity: | 0.203 | mm |
| Orifice height of the second cavity: | 0.762 | mm |
| Ratio of orifice height to width for oscillating strand | 3.75:1 | |
| Ratio of first and second orifice area | 2:1 | |
| Land spacing between orifices | 0.305 | mm |
| Flow rate of first polymer | 1.6 | kg/hr. |
| Flow rate of second polymer | 1.6 | kg/hr. |
| Flow rate ratio first to second polymer | 1:1 | |
| Extrusion temperature | 238° | C. |
| Quench roll temperature | 18° | C. |
| Quench takeaway speed | 1.5 | m/min. |

Using an optical microscope, the netting dimensions were measured and are shown below.

| | | |
|---|---|---|
| Netting thickness | 0.625 | mm |
| Netting basis weight | 270 | g/m² |
| Bond length in the machine direction | 0.6 | mm |
| Net bonding distance in the machine direction (pitch) | 2.1 | mm |
| First polymer strand width | 0.25 | mm |
| Second polymer strand width | 0.25 | mm |

The resulting netting had first to second strand cross-sections with a cross sectional area ratio of 1:1. A digital optical image at 10× of the netting is shown in FIG. 31, with first strands 3170a and second strands 3170b.

### Example 16

A co-extrusion die as generally depicted in FIG. 1 was prepared. The thickness of each shim was 4 mils (0.102 mm) Four identical shims were stacked together to create an orifice width of 16 mils (0.406 mm) to the first cavity. Two identical shims were stacked together to create an orifice width of 8 mils (0.203 mm) to the second cavity. Two identical shims were stacked together to create an effective shim width of 8 mils (0.203 mm) for the spacer between orifices. The shims were formed from stainless steel, with perforations cut by a wire electron discharge machining. The height of the first extrusion orifice was cut to 30 mils (0.762 mm) The height of the second set of extrusion orifices was cut to 30 mils (0.762 mm) The extrusion orifices were aligned in a collinear, alternating arrangement as shown in FIG. 32. The total width of the shim setup was 15 cm.

The inlet fittings on the two end blocks were each connected to a conventional single-screw extruder. A chill roll was positioned adjacent to the distal opening of the co-extrusion die to receive the extruded material. The extruder feeding the first cavity was loaded with styrene isoprene styrene block copolymer pellets (obtained under the trade designation “VECTOR 4114” from Dexco Polymers LP, Houston, Tex.), dry blended at 50% with C-5 hydrocarbon tackifier flakes (“WINGTAC PLUS”), and then dry blended with 1% antioxidant powder (obtained under the trade designation “IRGANOX 1010” from BASF, Luwigshafen, Germany).

The extruder feeding the second cavity was loaded with styrene-isoprene-styrene block copolymer pellets (“VECTOR 4114”), dry blended at 50% with C-5 hydrocarbon tackifier flakes (“WINGTAC PLUS”), and then dry blended with 1% antioxidant powder (“IRGANOX 1010”). Other process conditions are listed below:

| | |
|---|---|
| Orifice width for the first cavity: | 0.406 mm |
| Orifice height for the first cavity: | 0.762 mm |
| Orifice width of the second cavity: | 0.203 mm |
| Orifice height of the second cavity: | 0.762 mm |
| Ratio of orifice height to width for | 3.75:1 |
| oscillating strand | |
| Ratio of first and second orifice area | 2:1 |
| Land spacing between orifices | 0.203 mm |
| Flow rate of first polymer | 0.55 kg/hr. |
| Flow rate of second polymer | 1.43 kg/hr. |
| Flow rate ratio first to second polymer | 0.38:1 |
| Extrusion temperature | 150° C. |
| Quench roll temperature | 15° C. |
| Quench takeaway speed | 9 m/min. |

Using an optical microscope, the netting dimensions were measured and are shown below.

| | | |
|---|---|---|
| Netting thickness | 0.10 | mm |
| Netting basis weight | 30 | g/m² |
| Bond length in the machine direction | 2.3 | mm |
| Net bonding distance in the machine | 9 | mm |
| direction (pitch) | | |
| First polymer strand width | 0.01 | mm |
| Second polymer strand width | 0.015 | mm |

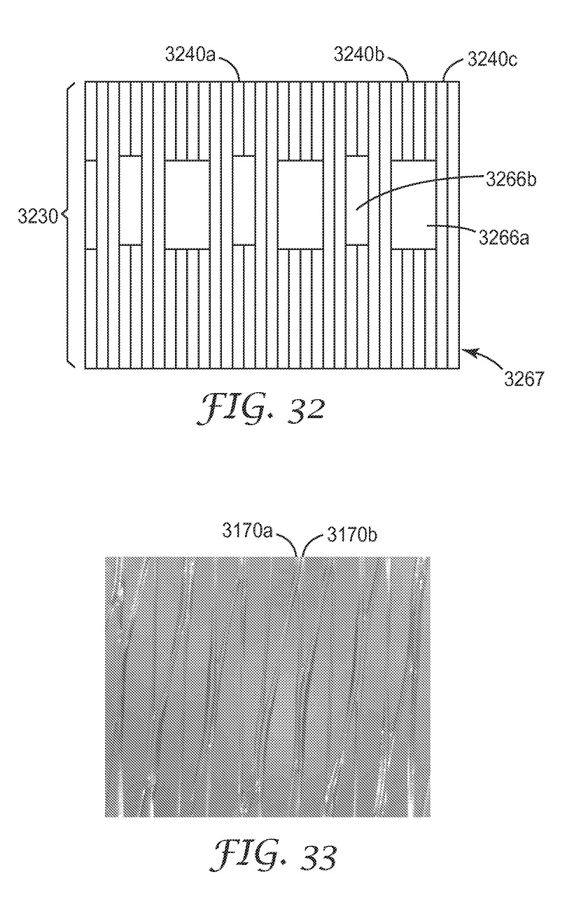

The resulting netting had first to second strand cross-sections with a cross sectional area ratio of 0.38:1. A digital optical image at 10× of the netting is shown in FIG. 33, with first strands 3370a and second strands 3370b.

### Example 17

A co-extrusion die as generally depicted in FIG. 1 was prepared. The thickness of each shim was 4 mils (102 mm) The shims were formed from stainless steel, with perforations cut by a wire electron discharge machining. The height of the first extrusion orifice was cut to 15 mils (0.381 mm) The height of the second set of extrusion orifices was cut to 5 mils (0.127 mm) The extrusion orifices were aligned in a collinear, alternating arrangement as shown in FIG. 34. The total width of the shim setup was 15 cm.

The inlet fittings on the two end blocks were each connected to a conventional single-screw extruder. A chill roll was positioned adjacent to the distal opening of the co-extrusion die to receive the extruded material. The extruder feeding the first cavity was loaded with thirty-five melt flow index polypropylene pellets (“EXXONMOBIL 3155 PP”).

The extruder feeding the second cavity was loaded with twelve melt flow index polypropylene pellets (“EXXONMOBIL 1024 PP”), dry blended at 50% with a polypropylene copolymer resin (obtained under the trade designation “VISTAMAX 6202” from ExxonMobil). Other process conditions are listed below:

| | |
|---|---|
| Orifice width for the first cavity: | 0.102 mm |
| Orifice height for the first cavity: | 0.381 mm |
| Orifice width of the second cavity: | 0.102 mm |
| Orifice height of the second cavity: | 0.127 mm |
| Ratio of orifice height to width for | 1.25:1 |
| oscillating strand | |
| Ratio of first and second orifice area | 3:1 |
| Land spacing between orifices | 0.102 mm |
| Flow rate of first polymer | 0.64 kg/hr. |
| Flow rate of second polymer | 0.59 kg/hr. |
| Flow rate ratio first to second polymer | 1.1:1 |
| Extrusion temperature | 232° C. |
| Quench roll temperature | 38° C. |
| Quench takeaway speed | 15.3 m/min. |

Using an optical microscope, the netting dimensions were measured and are shown below.

| | | |
|---|---|---|
| Netting thickness | 0.025 | mm |
| Netting basis weight | 8 | g/m² |
| Bond length in the machine direction | 1.3 | mm |
| Net bonding distance in the machine | 8 | mm |
| direction (pitch) | | |
| First polymer strand width | 0.02 | mm |
| Second polymer strand width | 0.02 | mm |

The resulting netting had first to second strand cross-sections with a cross sectional area ratio of 1.1:1. A digital optical image at 10× of the netting is shown in FIG. 35, with first strands 3570a and second strands 3570b.

### Example 18

Example 18 was made with the same die setup as Example 16. The inlet fittings on the two end blocks were each connected to a conventional single-screw extruder. A chill roll was positioned adjacent to the distal opening of the co-extrusion die to receive the extruded material. The extruder feeding the first cavity was loaded with propylene ethylene copolymer pellets (obtained under the trade designation “VERSIFY 4200” from Dow Chemical, Midland, Mich.), dry blended with 75% polypropylene impact copolymer pellets (obtained under the trade designation “DOW C700-35N” from Dow Chemical).

The extruder feeding the second cavity was loaded with propylene ethylene copolymer pellets (“VERSIFY 4200”). Other process conditions are listed below:

| | |
|---|---|
| Orifice width for the first cavity: | 0.406 mm |
| Orifice height for the first cavity: | 0.762 mm |
| Orifice width of the second cavity: | 0.203 mm |
| Orifice height of the second cavity: | 0.762 mm |
| Ratio of orifice height to width for | 3.75:1 |
| oscillating strand | |
| Ratio of first and second orifice area | 2:1 |
| Land spacing between orifices | 0.203 mm |
| Flow rate of first polymer | 0.95 kg/hr. |
| Flow rate of second polymer | 1.9 kg/hr. |
| Flow rate ratio first to second polymer | 0.5:1 |
| Extrusion temperature | 225° C. |
| Quench roll temperature | 95° C. |
| Quench takeaway speed | 2.1 m/min. |

Using an optical microscope, the netting dimensions were measured and are shown below.

| | | |
|---|---|---|
| Netting thickness | 0.50 | mm |
| Netting basis weight | 150 | g/m² |
| Bond length in the machine direction | 1.2 | mm |
| Net bonding distance in the machine | 3 | mm |
| direction (pitch) | | |
| First polymer strand width | 0.25 | mm |
| Second polymer strand width | 0.35 | mm |

The resulting netting had first to second strand cross-sections with a cross sectional area ratio of 0.5:1. A digital optical image at 10× of the netting is shown in FIG. 36, with first strands 3670a and second strands 3670b.

### Example 19

A co-extrusion die as generally depicted in FIG. 1 was prepared. In this example there are 3 zones of a continuous orifice that extrudes a film, and 2 zones of strand orifices to produce net. The sequence of zones is one film zone, one net zone, one film zone, one net zone, and then one film zone. Each zone was about 2 cm wide. The total width of the shim setup was 9.5 cm. The extrusion orifices were aligned in a collinear arrangement as shown in FIG. 37.

For the net zones, the following sequence was stacked together for a net extrusion width of 20 mm. The thickness of each shim was 4 mils (0.102 mm) Four identical shims were stacked together to create an orifice width of 16 mils (0.406 mm) to the first cavity. Two identical shims were stacked together to create an orifice width of 8 mils (0.203 mm) to the second cavity. Two identical shims were stacked together to create an effective shim width of 8 mils (0.203 mm) for the spacer between orifices. The shims were formed from stainless steel, with perforations cut by a wire electron discharge machining. The height of the first extrusion orifice was cut to 30 mils (0.762 mm) The height of the second set of extrusion orifices was cut to 30 mils (0.762 mm) The extrusion orifices were aligned in a collinear, alternating arrangement.

For the film zones, 190 identical shims were stacked together to create an effective orifice width of 760 mils (19 mm) The shim passageway of these shims was connected to the first cavity.

The inlet fittings on the two end blocks were each connected to a conventional single-screw extruder. A chill roll was positioned adjacent to the distal opening of the co-extrusion die to receive the extruded material. The extruder feeding the first cavity was loaded with polypropylene copolymer pellets (“VISTAMAX 6202”).

The extruder feeding the second cavity was loaded with polypropylene copolymer pellets (“VISTAMAX 6202”). Other process conditions are listed below:

| | |
|---|---|
| For the net zones: | |
| Orifice width for the first cavity: | 0.406 mm |
| Orifice height for the first cavity: | 0.762 mm |
| Orifice width of the second cavity: | 0.203 mm |
| Orifice height of the second cavity: | 0.762 mm |
| Ratio of orifice height to width for | 3.75:1 |
| oscillating strand | |
| Ratio of first and second orifice area | 2:1 |
| Land spacing between orifices | 0.203 mm |
| For the film zones: | |
| Orifice height connected to the first cavity. | 0.762 mm. |
| Flow rate of first polymer | 1.4 kg/hr. |
| Flow rate of second polymer | 0.6 kg/hr. |
| Extrusion temperature | 218° C. |
| Quench roll temperature | 15° C. |
| Quench takeaway speed | 1.5 m/min. |

Using an optical microscope, the netting dimensions were measured and are shown below.

| | |
|---|---|
| Netting thickness | 0.50 mm |
| Netting basis weight | 220 g/m² |
| Bond length in the machine direction | 0.9 mm |
| Net bonding distance in the machine | 2.6 mm |
| direction (pitch) | |
| First polymer strand width | 0.17 mm |
| Second polymer strand width | 0.21 mm |

The resulting netting had first to second strand cross-sections with a cross sectional area ratio of 0.9:1. A digital optical image of netting 3800 is shown in FIG. 38, with first strands 3870a, second strands 3870b, film regions 3899a, 3899b, and 3899c attached to netting 3871a and 3871b.

### Example 20

Example 20 was made with the same die and materials as Example 17.

| Flow rate of first polymer | 1.2 | kg/hr. |
|---|---|---|
| Flow rate of second polymer | 1.1 | kg/hr. |
| Flow rate ratio first to second polymer | 1.1:1 | |
| Extrusion temperature | 232° | C. |
| Quench roll temperature | 15° | C. |
| Quench takeaway speed | 18 | m/min. |

Using an optical microscope, the netting dimensions were measured and are shown below.

| | |
|---|---|
| Netting thickness | 0.06 mm |
| Netting basis weight | 14 g/m² |
| Bond length in the machine direction | 1.5 mm |
| Net bonding distance in the machine | 5 mm |
| direction (pitch) | |
| First polymer strand width | 0.03 mm |
| Second polymer strand width | 0.03 mm |

The net material was then stretched using a seven roll fiber stretching process. The process rolls were 19 cm diameter. The roll temperatures and speed were run as follows:

| | | |
|---|---|---|
| Roll 1 | 80° C. | 4 m/min |
| Roll 2 | 80° C. | 4 m/min |
| Roll 3 | 80° C. | 4 m/min |
| Roll 4 | 20° C. | 18 m/min |
| Roll 5 | 20° C. | 18 m/min |
| Roll 6 | 20° C. | 18 m/min |
| Roll 7 | 80° C. | 18 m/min |

The net was collected without tension after roll 7 by allowing the web to drop into a box. This allows the net to relax and form a web that has a bulk thickness greater than the initial material.

| | |
|---|---|
| Initial net thickness | 0.50 mm |
| Final net thickness | 5 mm |
| First strand width after stretching | 0.015 mm |
| Second strand width after stretching | 0.015 mm |

A digital optical image of the netting is shown in FIG. 39, with first strands 3970a and second strands 3970b.

### Example 21

A layered net sample was prepared as loop for a hook and loop attachment article. A hook engaging net was prepared and intermittently bonded to a base net layer as follows.

The engagement net layer was prepared with the same die setup and materials as

Example 17.

| Flow rate of first polymer | 2.7 | kg/hr. |
|---|---|---|
| Flow rate of second polymer | 2.7 | kg/hr. |
| Flow rate ratio first to second polymer | 1:1 | |
| Extrusion temperature | 232° | C. |
| Quench roll temperature | 20° | C. |
| Quench takeaway speed | 10 | m/min. |

The netting was stretched in line 6:1. It was then allowed to relax and curl into a bulk thickness greater than a flat laid example. The stretched, relaxed netting had a basis weight of 4 g/m².

The loop article base net layer was prepared with the same die as Example 17. The inlet fittings on the two end blocks were each connected to a conventional single-screw extruder. A chill roll was positioned adjacent to the distal opening of the co-extrusion die to receive the extruded material. The extruder feeding the first and second cavity was loaded with thirty-five melt flow index polypropylene pellets (“EXXONMOBIL 3155 PP”). Other process conditions are listed below:

| Flow rate of first polymer | 2.7 | kg/hr. |
|---|---|---|
| Flow rate of second polymer | 2.7 | kg/hr. |
| Flow rate ratio first to second polymer | 1:1 | |
| Extrusion temperature | 232° | C. |
| Quench roll temperature | 20° | C. |
| Quench takeaway speed | 15 | m/min. |
| Netting basis weight | 16 | g/m² |

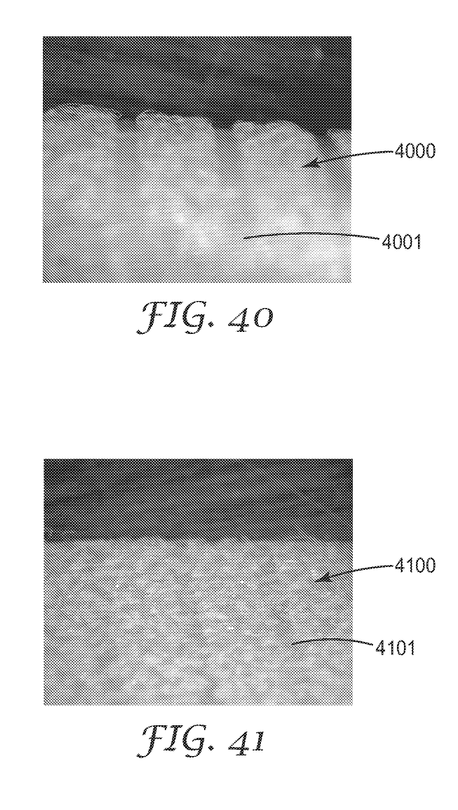

Three layers of engagement net were bonded to one layer of base net with ultrasonic welding. Bonding was performed on a sonic bonder (obtained under the trade designation “0 MHZ BRANSON 2000AED” from Branson Ultrasonics Corporation, Danbury, Conn.) with a 19 mm×165 mm flat horn. The anvil was a grooved plate which had a bond pitch of 3.6 mm and a bond width of 1 mm. The bonding times were between 0.5 and 0.75 second with a 0.5 second hold time after the bond. The bonding energy was adjusted to provide a secure bond without excessive melting of the strand. Bond forces were about 240 kg. A digital optical image at 10× of the netting 4000 having bond lines 40001 is shown in FIG. 40.

Peel force to hook was measured with the Shear-Engaged Peel Test. Ten replicates were performed. The average peel force was calculated at 82 grams.

Dynamic shear was measured with the 180 Degree Dynamic Shear Test. Ten replicates were performed. The average shear value of the ten replicates was 1993 grams.

### Example 22

A layered net sample was prepared as loop for a hook and loop attachment article similar to Example 21. In this example, three layers of the hook engaging net was intermittently bonded to a base net layer of 30 g/m² polypropylene spunbond nonwoven. A digital optical image at 10× of the netting 4100 having bond lines 4101 is shown in FIG. 41.

Peel force to hook was measured with the Shear-Engaged Peel Test. Ten replicates were performed. The average peel force was calculated at 100 grams.

Dynamic shear was measured with the Dynamic Shear Test. Ten replicates were performed. The average shear value of the ten replicates was 2326 grams.

### Example 23

A layered net sample was prepared as loop for a hook and loop attachment article. A hook engaging net was prepared and intermittently bonded to a base net layer as follows.

The engagement net layer was prepared with the same die setup as Example 17. The inlet fittings on the two end blocks were each connected to a conventional single-screw extruder. A chill roll was positioned adjacent to the distal opening of the co-extrusion die to receive the extruded material. The extruder feeding the first and second cavity was loaded with thirty-five melt flow index polypropylene pellets (“EXXONMOBIL 3155 PP). Other process conditions are listed below:

| Flow rate of first polymer | 2.7 | kg/hr. |
|---|---|---|
| Flow rate of second polymer | 2.7 | kg/hr. |
| Flow rate ratio first to second polymer | 1:1 | |
| Extrusion temperature | 232° | C. |
| Quench roll temperature | 20° | C. |
| Quench takeaway speed | 40 | m/min. |
| Netting basis weight | 5.5 | g/m² |

The loop article base net layer was prepared the same as the base net layer of Example 21.

Three layers of engagement net were bonded to one layer of base net with ultrasonic welding. Bonding was performed on a sonic bonder (“20 MHZ BRANSON 2000AED”) with a 19 mm×165 mm flat horn. The anvil was a grooved plate which had a bond pitch of 3.6 mm and a bond width of 1 mm. This example is an arucuate fiber construction whereby the fibers are pressed into the grooves between the bonding ribs using an array of wires. This forms fiber loops in the final loop construction. The bonding times were between 0.5 and 0.75 second with a 0.5 second hold time after the bond. Bond forces were approximately 240 kg. A digital optical image at 10× of the netting 4200 having bond lines 4201 is shown in FIG. 42.

Peel force to hook was measured with the Shear-Engaged Peel Test. Ten replicates were performed. The average peel force was calculated at 294 grams.

Dynamic shear was measured with the Dynamic Shear Test. Ten replicates were performed. The average shear value of the ten replicates was 3950 grams.

### Example 24

A layered net sample was prepared as loop for a hook and loop attachment article similar to Example 23. In this example, four layers of the hook engaging net was intermittently bonded to a base net layer of beta nucleated polypropylene film. A digital optical image at 10× of the netting 4300 having bond lines 4301 is shown in FIG. 43.

Peel force to hook was measured with the Shear-Engaged Peel Test. Ten replicates were performed. The average peel force was calculated at 318 grams.

Dynamic shear was measured with the Dynamic Shear Test. Ten replicates were performed. The average shear value of the ten replicates was 4209 grams.

Foreseeable modifications and alterations of this disclosure will be apparent to those skilled in the art without departing from the scope and spirit of this invention. This invention should not be restricted to the embodiments that are set forth in this application for illustrative purposes.

1. A netting comprising an array of polymeric strands periodically joined together at bond regions throughout the array, but do not substantially cross over each other, wherein the netting has a thickness up to 750 micrometers.

2. An article comprising two nettings of claim 1 with a ribbon region disposed there between.

3. An article comprising the netting of claim 1 disposed between two ribbon regions.

4. A method of making the netting of claim 1, the method comprising one of Method I or Method II:
Method I
providing an extrusion die comprising a plurality of shims positioned adjacent to one another, the shims together defining a cavity, the extrusion die having a plurality of first dispensing orifices in fluid communication with the cavity and a plurality of second dispensing orifices in fluid communication with the cavity, such that the first and second dispensing orifices are alternated; and
dispensing first polymeric strands from the first dispensing orifices at a first strand speed while simultaneously dispensing second polymeric strands from the second dispensing orifices at a second strand speed, wherein the first strand speed is at least 2 times the second strand speed to provide the netting; or
Method II
providing an extrusion die comprising a plurality of shims positioned adjacent to one another, the shims together defining a first cavity and a second cavity, the extrusion die having a plurality of first dispensing orifices in fluid communication with the first cavity and having a plurality of second dispensing orifices connected to the second cavity, such that the first and second dispensing orifices are alternated; and
dispensing first polymeric strands from the first dispensing orifices at a first strand speed while simultaneously dispensing second polymeric strands from the second dispensing orifices at a second strand speed, wherein the first strand speed is at least 2 times the second strand speed to provide the netting.

5. An extrusion die comprising one of:
(I)
a plurality of shims positioned adjacent to one another, the shims together defining a cavity and a dispensing surface, wherein the dispensing surface has an array of first dispensing orifices alternating with an array of second dispensing orifices, wherein the plurality of shims comprises a plurality of a repeating sequence of shims comprising a shim that provides a fluid passageway between the cavity and the first dispensing orifices and a shim that provides a fluid passageway between the cavity and the second dispensing orifices where the first array of fluid passageways has greater fluid restriction than the second array of fluid passageways; or
(II)
a plurality of shims positioned adjacent to one another, the shims together defining a first cavity, a second cavity, and a dispensing surface, wherein the dispensing surface has an array of first dispensing orifices alternating with an array of second dispensing orifices, wherein the plurality of shims comprises a plurality of a repeating sequence of shims comprising a shim that provides a fluid passageway between the first cavity and one of the first dispensing orifices and a shim that provides a fluid passageway between the second cavity and one of second the dispensing orifices.

6. An extrusion die comprising one of:
(I)
a plurality of shims positioned adjacent to one another, the shims together defining a cavity and a dispensing surface, wherein the dispensing surface has at least one net-forming zone and at least one film-forming zone, wherein the net-forming zone has an array of first dispensing orifices alternating with an array of second dispensing orifices; or
(II)
a plurality of shims positioned adjacent to one another, the shims together defining a first cavity, a second cavity, and a dispensing surface, wherein the dispensing surface has at least one net-forming zone and at least one film-forming zone, wherein the net-forming zone has an array of first dispensing orifices alternating with an array of second dispensing orifices.

7. An attachment system comprising a netting and an array of engagement posts for engaging with the netting, the netting comprising an array of polymeric strands periodically joined together at bond regions throughout the array, wherein the netting has a thickness up to 750 micrometers.

8. The attachment system of claim 7, where there is a ribbon region adjacent and connected to one side of the netting.

9. An attachment system comprising an array of engagement posts engaged with a netting, the netting comprising an array of polymeric strands periodically joined together at bond regions throughout the array, wherein the netting has a thickness up to 750 micrometers.

10. The attachment system of claim 9, where there is a ribbon region adjacent and connected to one side of the netting.

11. An array of alternating first and second polymeric strands, wherein the first and second strands periodically join together at bond regions throughout the array, wherein at least one of the first or second strands have a property of having been stretched beyond a yield point of the respective strands, wherein the first strands have an average first yield strength, and wherein the second strands have an average second yield strength that is different than the first yield strength.

12. An article comprising two arrays of claim 11 with a ribbon region disposed there between.

13. An article comprising the array of claim 11 disposed between two ribbon regions.

14. The array of claim 1, wherein both the first and second strands have been stretched beyond a yield point of the respective strands.
